(19) United States
(12) Patent Application Publication
(10) Pub. No.: US 2026/0211364 A1
(43) Pub. Date: Jul. 23, 2026

(54) CURL CORRECTING APPARATUS AND IMAGE FORMING SYSTEM

(71) Applicant: CANON KABUSHIKI KAISHA, Tokyo (JP)

(72) Inventors: KAZUYA NUMATA, Ibaraki (JP); YUMA INUI, Ibaraki (JP)

(21) Appl. No.: 19/448,234

(22) Filed: Jan. 14, 2026

(30) Foreign Application Priority Data
Jan. 21, 2025 (JP) 2025-008761

(51) Int. Cl. G03G 15/00

(52) U.S. Cl. CPC G03G 15/6576; G03G 15/5012; G03G 15/5029; G03G 15/6552; G03G 2215/00616; G03G 2215/00721

(57) ABSTRACT

The curl correcting apparatus includes a curl correcting portion including a first rotary member, and a second rotary member, the curl correcting portion being configured to correct curl of a sheet that passes through a nip portion between the first rotary member and the second rotary member, a first detection portion configured to detect a curl state of the sheet conveyed, a second detection portion disposed in a stacking portion configured to stack the sheet discharged from the curl correcting portion, the second detection portion being configured to detect a curl state of the sheet stacked on the stacking portion, and a control portion configured to adjust a pressing amount. The control portion is configured to set the pressing amount based on a first detection result by the first detection portion and a second detection result by the second detection portion.

### BACKGROUND

### Field of the Technology

The present disclosure relates to a curl correcting apparatus which corrects the curl of sheets, and an image forming system in which the curl correcting apparatus is used appropriately.

### Description of the Related Art

In recent years, it has been known that various types of curl, such as heat curl, toner curl, and conveyance path curl, may occur in sheets in an electrophotographic image forming apparatus. For example, the heat curl is caused by the passage of a sheet through a fixing apparatus that fixes a toner image to the sheet by heating the toner image. The toner curl is caused by the contraction of the toner. The conveyance path curl is caused by the passage of a sheet through a curved sheet conveyance path. In particular, in the digital printing, since the variable data printing can be performed on each of sheets, various types of curl will occur in accordance with print images.

If a large curl occurs in a sheet, various problems may occur. For example, failure of stacking may occur at a discharging port of an image forming apparatus, or a sheet may fall when a stacked sheet bundle is conveyed to a post-processing apparatus. In another case, failure of feeding of sheets, failure of alignment of sheets, or failure of stapling of sheets may occur in the post-processing apparatus.

For solving such problems, Japanese Patent Application Publication No. H07-137912 disclose a curl correcting apparatus that corrects the curl that has occurred in a sheet. For example, a known curl correcting apparatus includes a pair of rollers having different hardnesses, and the pressing force of the rollers can be changed. The rollers having different hardnesses are in pressure contact with each other, so that a curved nip is formed. Thus, if a sheet is conveyed by the roller pair, the sheet is forced to deform, so that the curl of the sheet can be corrected. The amount of correction can be adjusted freely by changing the pressing force of the roller pair. The amount of correction by the decurler is determined by predicting the amount (value) of curl that will occur. Specifically, the amount of curl is predicted by using conditions, such as mechanical property values, which includes a sheet thickness, and the amount of heat applied by the fixing apparatus.

On the other hand, even if sheets have an identical type, the amount of curl that occurs in the sheets may vary, depending on the difference in production lot. Furthermore, the amount of curl that occurs in the sheets may also vary in a case where the amount of moisture contained in the sheets vary, depending on the storage condition of the sheets and on the environment where the image forming apparatus is installed. Thus, even if the amount of curl that occurs in sheets is predicted by using various types of parameters, and the curl correction amount is determined based on the prediction, the curl may be left without completely corrected, or may be overcorrected (overcorrection). For solving this problem, Japanese Patent Application Publication No. 2020-134750 proposes a technique that detects the shape of a sheet that is being conveyed, and that corrects the amount of curl by using the information on the amount of curl detected.

However, it is difficult to provide an optimum curl correction amount for the amount of curl that is actually occurring. Thus, even if a curl of a sheet is corrected, a slight curl may be left, not a little, in the sheet. If the sheet in which the slight curl is left is discharged from the image forming apparatus and stacked, the shape of a sheet bundle stacked may become unstable.

### SUMMARY

The present disclosure provides a curl correcting apparatus and an image forming system that can appropriately set the amount of correction.

According to an aspect of the present disclosure, a curl correcting apparatus includes a curl correcting portion including a first rotary member, and a second rotary member configured to abut against the first rotary member, the curl correcting portion being configured to correct curl of a sheet that passes through a nip portion between the first rotary member and the second rotary member when the first rotary member is pressed by the second rotary member, a first detection portion configured to detect a curl state of the sheet conveyed in a conveyance path by a conveyance roller, a second detection portion disposed in a stacking portion configured to stack the sheet discharged from the curl correcting portion, the second detection portion being configured to detect a curl state of the sheet stacked on the stacking portion, and a control portion configured to adjust a pressing amount by which the second rotary member presses the first rotary member of the curl correcting portion. The control portion is configured to set the pressing amount based on a first detection result by the first detection portion and a second detection result by the second detection portion.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an image forming system of a first embodiment.

FIG. 2A is a perspective view illustrating a downward curl of the first embodiment that occurs in a sheet.

FIG. 2B is a perspective view illustrating an upward curl of the first embodiment that occurs in a sheet.

FIG. 3 is a cross-sectional view illustrating a curl correcting portion of the first embodiment.

FIG. 4 is a cross-sectional view illustrating a default state of the curl correcting portion of the first embodiment.

FIG. 5 is a cross-sectional view illustrating a state where the curl correcting portion of the first embodiment corrects a downward curl.

FIG. 6 is a cross-sectional view illustrating a state where the curl correcting portion of the first embodiment corrects an upward curl.

FIG. 7 is a control block diagram of a curl correcting apparatus of the first embodiment.

FIG. 8 is a cross-sectional view illustrating a configuration of an inline detection portion of the first embodiment.

FIG. 9 is a diagram illustrating a change in output from a first sensor and a second sensor in a case where an uncurled sheet illustrated in FIG. 8 is conveyed.

FIG. 10 is a cross-sectional view illustrating a case where a sheet that is curled upward is conveyed to the inline detection portion of the first embodiment.

FIG. 11 is a diagram illustrating a change in output from the first sensor and the second sensor in a case where the sheet illustrated in FIG. 10 and curled upward is conveyed.

FIG. 12 is a cross-sectional view illustrating a case where a sheet that is curled upward more than the sheet illustrated in FIG. 10 is conveyed to the inline detection portion.

FIG. 13 is a diagram illustrating a change in output from the first sensor and the second sensor in a case where the sheet illustrated in FIG. 12 and curled upward is conveyed.

FIG. 14 is a cross-sectional view illustrating a case where a sheet that is curled downward is conveyed to the inline detection portion of the first embodiment.

FIG. 15 is a diagram illustrating a change in output from the first sensor and the second sensor in a case where the sheet illustrated in FIG. 14 and curled downward is conveyed.

FIG. 16 is a diagram illustrating a configuration in which a plurality of first sensors and a plurality of second sensors are disposed in the inline detection portion.

FIG. 17 is a cross-sectional view illustrating the curl correcting apparatus of the first embodiment.

FIG. 18A is a diagram illustrating an image captured by a CCD camera in a case where an upward curl is left in an uppermost sheet of a stacked bundle of the first embodiment.

FIG. 18B is a diagram illustrating an image captured by the CCD camera in a case where a downward curl is left in an uppermost sheet of a stacked bundle of the first embodiment.

FIG. 19 is a flowchart illustrating a process executed by a CPU of a controller, as control that the curl correcting apparatus of the first embodiment performs for correcting the curl correction amount.

FIG. 20 is a diagram illustrating a flow in which a plurality of sheets is conveyed to the curl correcting apparatus of the first embodiment and the curl correction amount is corrected.

FIG. 21 is a control block diagram of a curl correcting apparatus of a second embodiment.

FIG. 22 is a flowchart illustrating a process executed by a CPU of a controller, as control that the curl correcting apparatus of the second embodiment performs for correcting the curl correction amount.

FIG. 23 is a diagram illustrating a flow in which a plurality of sheets is conveyed to the curl correcting apparatus of the second embodiment and the curl correction amount is corrected.

FIG. 24 is a diagram illustrating a sheet detected in each detection in a case where the cycle in which a stacked-bundle detection portion performs the detection in a curl correcting apparatus of another embodiment is shortened.

FIG. 25 is a diagram illustrating a sheet detected in each detection in a case where the stacked-bundle detection portion performs the detection when printing for one copy is switched to printing for another in a curl correcting apparatus of another embodiment.

### DESCRIPTION OF THE EMBODIMENTS

### First Embodiment

Hereinafter, a first embodiment of the present disclosure will be described in detail with reference to the accompanying drawings. In the first embodiment, an image forming apparatus, such as a copying machine, a facsimile, a printer, or a multi-function printer that includes a plurality of functions of the copying machine, the facsimile, and the printer, will be described as an example. The image forming apparatus forms an electrostatic latent image on an image bearing member by using the electrophotographic system, the electrostatic recording system, or the like; and develops the electrostatic latent image into a toner image by using developer stored in a developing apparatus. However, since an image forming system that includes a curl correcting apparatus of the present disclosure and the image forming apparatus is one example, the scope of the present disclosure is not limited to the image forming system. In addition, the present disclosure is not limited to an image forming apparatus 1 that is a tandem-type full-color printer, and the image forming apparatus 1 may be an image forming apparatus that has another system. In addition, the present disclosure is also not limited to a full-color printer, and may be applied to a monochrome or mono-color printer or an ink-jet printer.

### Overall Configuration of Image Forming Apparatus

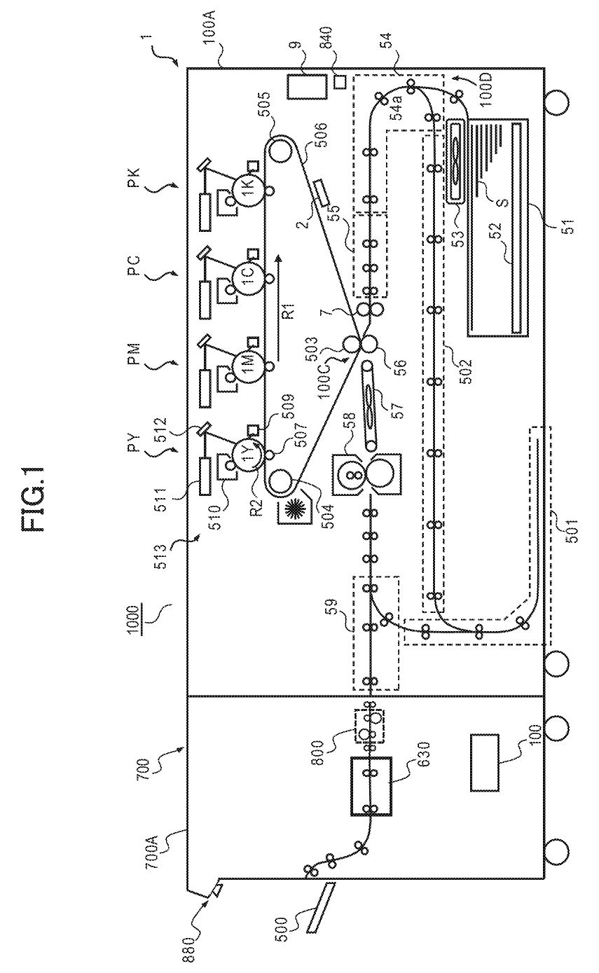

First, an overall configuration of an image forming system 1000 of the first embodiment will be described. FIG. 1 is a cross-sectional view of the image forming system 1000 that includes the intermediate-transfer tandem image forming apparatus 1 and a curl correcting apparatus 700. In the image forming apparatus 1, image forming portions for four colors are disposed side by side on an intermediate transfer belt 506. The image forming apparatus 1 is an apparatus, such as a copying machine, a facsimile, or a multi-function printer, that forms an image on a sheet used as a recording medium. In addition, the image forming apparatus 1 can perform printing for work other than general office work. The recording medium may be of various types of sheets including a paper sheet, such as a sheet for any purpose or an envelope, a glossy paper sheet, a plastic film such as an overhead projector sheet, or a cloth sheet.

An apparatus body 100A of the image forming apparatus 1 accommodates a feeding cassette 51 that stores a sheet S, and an image forming engine 513 that forms an image on the sheet S fed from the feeding cassette 51. The image forming engine 513 that is one example of an image forming portion includes four image forming portions PY, PM, PC, and PK, and the intermediate transfer belt 506. The four image forming portions PY, PM, PC, and PK respectively form toner images of yellow, magenta, cyan, and black. The image forming engine 513 forms an image on the sheet S by using the intermediate-transfer tandem system. The image forming portions PY, PM, PC, and PK are electrophotographic units that respectively include photosensitive drums 1Y, 1M, 1C, and 1K that are photosensitive members.

The image forming portions PY, PM, PC, and PK have the same configuration except that the colors of toner used by the image forming portions for the development are different from each other. Thus, in the following description, a configuration of the image forming engine 513 and an image forming process of a toner image will be described, referring to the image forming portion PY, as an example, that corresponds to yellow. The image forming portion PY includes, in addition to the photosensitive drum 1Y, an exposure apparatus 511, a developing apparatus 510, and a drum cleaner 509. The photosensitive drum 1Y is a drum-like photosensitive member that includes a photosensitive layer formed on an outer circumferential portion, and rotates in a direction (i.e., a direction indicated by an arrow R2 in FIG. 1) that is along a rotational direction (i.e., a direction indicated by an arrow R1 in FIG. 1) of the intermediate transfer belt 506. The surface of the photosensitive drum 1Y is supplied with electric charge from a charging portion, such as a charging roller, and is charged with electricity. The exposure apparatus 511 forms an electrostatic latent image on the surface of the photosensitive drum 1Y by emitting a laser beam modulated in accordance with image information, to the surface of the photosensitive drum 1Y, and by scanning the surface of the photosensitive drum 1Y with the laser beam by using an optical system that includes a reflecting apparatus 512. The developing apparatus 510 stores developer that contains toner, and supplies the toner to the photosensitive drum 1Y, so that the electrostatic latent image is visualized into a toner image. The toner image formed on the photosensitive drum 1Y is primary-transferred onto the intermediate transfer belt 506 in a primary transfer portion that is a nip portion between a primary transfer roller 507 and the intermediate transfer belt 506. The remaining toner left on the photosensitive drum 1Y after the transfer is removed by the drum cleaner 509.

The intermediate transfer belt 506 is wound around a driving roller 504, a driven roller 505, a secondary transfer inner roller 503, and the primary transfer roller 507, and is driven and rotated in a clockwise direction (i.e., a direction indicated by the arrow R1) in FIG. 1, by the driving roller 504. The above-described image forming processes in the image forming portions PY, PM, PC, and PK are performed in parallel with each other, and multiple transfer is performed so that four-color toner images are put on each other. As a result, a full-color toner image is formed on the intermediate transfer belt 506. The toner image is conveyed to a secondary transfer portion 100C while borne by the intermediate transfer belt 506. The secondary transfer portion 100C is formed as a nip portion between a secondary transfer roller 56, which serves as a transfer portion, and the secondary transfer inner roller 503. The secondary transfer roller 56 is applied with a bias voltage whose polarity is opposite to the charging polarity of the toner, so that the toner image is secondary-transferred onto the sheet S. The remaining toner left on the intermediate transfer belt 506 after the transfer is removed by a belt cleaner.

The sheet S onto which the toner image has been transferred is delivered to a fixing apparatus 58 by a pre-fixing conveyance portion 57. The fixing apparatus 58 includes a fixing roller pair that nips and conveys the sheet S, and a heat source such as a halogen heater; and applies pressure and heat to the toner image borne by the sheet S. With this operation, the toner particles are melted and solidifies, so that the toner image is fixed to the sheet S.

Next, a sheet conveyance process for conveying the sheet will be described. A sheet conveyance apparatus 100D of the first embodiment feeds the sheet S stored in the feeding cassette 51, and discharges the sheet S on which an image is formed, to the outside of the apparatus body 100A. The sheet conveyance apparatus 100D includes a sheet feeding portion 53, a sheet conveyance portion 54, a skew correcting portion 55, a branch conveyance portion 59, a reverse conveyance portion 501, and a duplex conveyance portion 502. The feeding cassette 51 is attached to the apparatus body 100A such that the feeding cassette 51 can be drawn out from the apparatus body 100A. The sheet S is stored in the feeding cassette 51 in a state where the sheet S is stacked on a lifting/lowering plate 52 that can be lifted and lowered. The sheets S stored in the feeding cassette 51 are fed, one by one, by the sheet feeding portion 53. The sheet feeding portion 53 may have a belt system or a frictional separation system. The belt system conveys the sheet S while causing a drawing fan to attract the sheet S to a belt member. The frictional separation system uses a roller or a pad. The sheet S sent from the sheet feeding portion 53 is conveyed along a feeding path 54a by conveyance roller pairs of the sheet conveyance portion 54, and is delivered to the skew correcting portion 55.

The sheet S is delivered to the skew correcting portion 55, and skew correction and timing correction are performed. After that, the sheet S is conveyed toward the secondary transfer portion 100C. In this operation, a registration roller pair 7 included in the skew correcting portion 55 sends the sheet S into the secondary transfer portion 100C at a timing in accordance with the degree of progress of the image forming process performed by the image forming portions PY, PM, PC, and PK. In the secondary transfer portion 100C, the toner image is transferred to the sheet S; and the image is fixed to the sheet S by the fixing apparatus 58. After that, the sheet S is conveyed to the branch conveyance portion 59 that branches the conveyance path of the sheet S. In a case where the image formation for the sheet S is completed, the sheet S is conveyed by a discharging roller pair, to the curl correcting apparatus 700 disposed downstream of the apparatus body 100A in the conveyance direction.

In a case where an image is to be formed on the back side of the sheet S, the sheet S is delivered to the duplex conveyance portion 502 via the reverse conveyance portion 501. The reverse conveyance portion 501 includes a reversing roller pair that can rotate in forward and reverse directions, and delivers the sheet S to the duplex conveyance portion 502 in a state where the front side and the back side of the sheet S are reversed to each other by using a switch-back system that reverses the front side and the back side of the sheet S. The duplex conveyance portion 502 conveys the sheet S toward the skew correcting portion 55 again via the sheet conveyance portion 54. Then, an image is formed on the back side of the sheet S, and after that, the sheet S is conveyed to the curl correcting apparatus 700. After passing through the curl correcting apparatus 700, the sheet S is discharged from an apparatus body 700A of the curl correcting apparatus 700, and is stacked on a stacking tray 500.

The image forming apparatus 1 includes a main-body control portion 9 that controls the operation of the whole of the image forming apparatus 1, depending on image information sent from an external PC or read from a document. The main-body control portion 9 includes a CPU and a memory, and controls each of the above-described components of the image forming apparatus 1. The CPU outputs an output signal to each electric component, depending on a detection signal sent from each sensor or on information stored in the memory, for operating the electric component at a desired timing and with a necessary amount of control. The memory stores data necessary for controlling each unit, and the CPU reads data stored in the memory and writes data to the memory.

### Principle of Occurrence of Curl

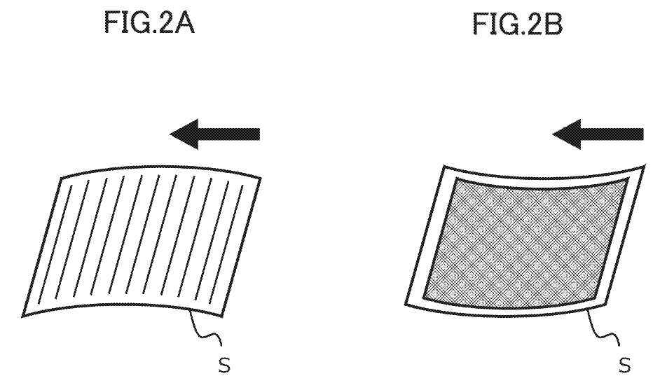

Next, the curl that occurs in a sheet will be described with reference to FIG. 2. FIG. 2A is a diagram illustrating a state where a downward curl (which is hereinafter referred to also as a heat curl) has occurred. The downward curl is a curl in which the downstream edge and the upstream edge of the sheet S in the conveyance direction has moved downward with respect to a center portion of the sheet S. FIG. 2B is a diagram illustrating a state where an upward curl (which is hereinafter referred to also as a toner curl) has occurred. The upward curl is a curl in which the downstream edge and the upstream edge of the sheet S in the conveyance direction has moved upward with respect to a center portion of the sheet S.

The sheet S is applied with heat from a heat source, such as a heater, when the sheet S passes through the fixing apparatus 58. In this case, a difference in temperature generally occurs between an image-formed surface and a surface opposite to the image-formed surface. The image-formed surface has a high temperature because the toner is melted. As a result, the moisture of the sheet S moves in the sheet S in the nip of the fixing apparatus 58, so that the back surface has more moisture than the high-temperature image-formed surface does. When the sheet S contacts the air after passing through the fixing apparatus 58, the moisture evaporates from the high-temperature sheet S. In this case, the moisture evaporates more from the back surface that contains more moisture. If the material of the sheet S is pulp, the sheet S contracts more as the amount of evaporation increases. Thus, the image-formed surface is pulled by the back surface that has a larger amount of contraction, so that the downward curl occurs as illustrated in FIG. 2A. As described above, the downward curl is a curl in which the downstream edge and the upstream edge of the sheet S in the conveyance direction has moved downward with respect to a center portion of the sheet S.

In addition, the toner is melted at a high temperature and solidifies in the fixing apparatus 58. When the toner and the sheet S contact the air after passing through the fixing apparatus 58, the temperature of the toner and the sheet S decreases, so that the toner and the sheet S contract. In general, since the material of the toner and the material of the sheet S have different coefficients of linear expansion, the front surface and the back surface of the sheet S have different amounts of contraction in a case where the temperature decreases. Since the toner layer of the front surface generally has a larger amount of contract, the upward curl will occur, as a result of this, as illustrated in FIG. 2B. As described above, the upward curl is a curl in which the edge portions of the sheet S have bent upward. The toner curl varies because the thickness of the toner layer changes in accordance with the change in image density.

The curl state of the sheet is represented by a total value of the heat curl and the toner curl, and includes the amount and direction of the curl. The amount of curl (i.e., curl amount) is the amount by which an edge portion, in the conveyance direction, of the sheet is curled with respect to a center portion of the sheet. The direction of curl is a direction in which the edge portion of the sheet is curled with respect to a center portion of the sheet. Thus, the curl state changes, depending on various parameters including the material, thickness, stiffness, water content, and temperature of the sheet, the environmental temperature, the environmental humidity, the fixing temperature, and the image density. In addition, the water content of the sheet changes, affected by conditions (e.g., the environmental temperature, the environmental humidity, and the fixing temperature) that change continuously. Thus, even if the printing condition (e.g., physical property of sheet, and image) is constant, the difference occurs in the change in curl state that changes with time, so that the difference also occurs in the final amount of deformation.

A curl correcting portion 800 cancels the curl by deforming the curl in a direction opposite to a direction in which the curl has occurred. Thus, the curl correcting apparatus 700 is required to predict, in advance, the state of curl that occurs depending on the above-described various conditions, and set the amount of correction suitable to the prediction.

### Curl Correcting Portion

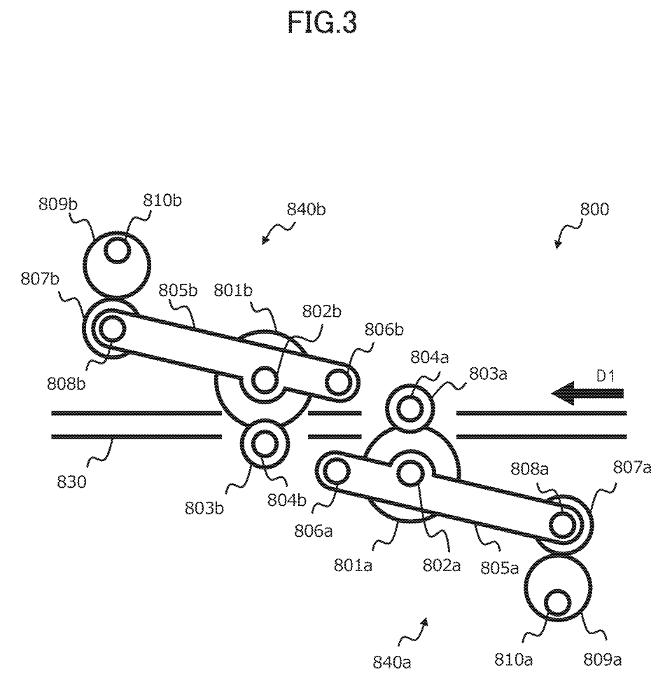

Next, the curl correcting portion 800 that can correct the curl of the sheet S in the curl correcting apparatus 700 of the first embodiment will be described with reference to FIGS. 3 to 7. FIG. 3 is a cross-sectional view illustrating a configuration of the curl correcting portion 800. As illustrated in FIG. 3, the curl correcting portion 800 includes a frame (not illustrated), a conveyance path 830, an upward correcting portion 840a disposed upstream in the conveyance direction of the conveyance path 830, and a downward correcting portion 840b disposed downstream in the conveyance direction of the conveyance path 830.

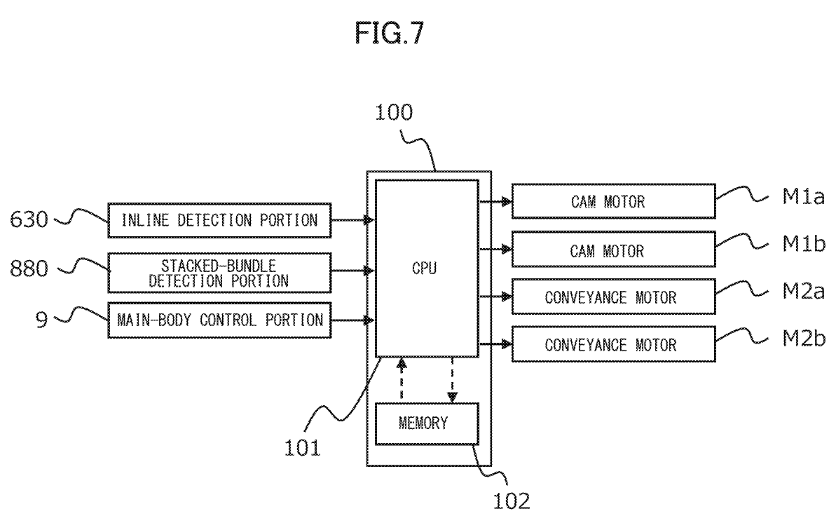

The upward correcting portion 840a includes a sponge roller 801a and a metal roller 803a that substantially face each other. The metal roller 803a is rotatably fixed to the frame via a metal roller shaft 804a. The sponge roller 801a is rotatably fixed to a swing arm 805a via a sponge roller shaft 802a. One end of the swing arm 805a is swingably connected to the frame via a swing shaft 806a, and the other end is connected with a follower 807a such that the follower 807a can rotate via a follower shaft 808a. In addition, a cam 809a is rotatably fixed to the frame via an eccentric cam shaft 810a. The surface of the cam 809a is in contact with the follower 807a. The angle of the cam 809a is controlled by a cam motor M1a (see FIG. 7) that receives an instruction from a controller 100 (see FIG. 7). The relative distance between the cam shaft 810a and the follower shaft 808a changes, so that the angle of the swing arm 805a changes and the sponge roller 801a is displaced in the thickness direction of the sheet S. In this manner, the pressing force between the sponge roller 801a and the metal roller 803a can be changed.

In the upward correcting portion 840a, the sponge roller 801a and the metal roller 803a are pressed against each other by a predetermined pressing force, and the metal roller 803a that has higher hardness sinks into the sponge roller 801a that has lower hardness. As a result, a curved nip is formed. When the sheet S passes through the nip (i.e., a nip portion), the sheet S is forced to deform along the metal roller 803a that has a shorter radius, and is re-formed. The metal roller 803a sinks more into the sponge roller 801a and the sponge roller 801a deforms more as the nip pressure increases, so that the width of the nip in the conveyance direction increases. As a result, the time in which the sheet S that passes through the nip is forced to deform becomes longer, so that the curl can be corrected more forcefully. In this manner, the curl correcting portion 800 controls the rotation angle of the cam 809a by using the cam motor M1a, and thereby can adjust the amount of correction that the upward correcting portion 840a performs on the sheet S.

The metal roller 803a is driven and rotated in the conveyance direction of the sheet S, by a conveyance motor M2a (see FIG. 7). The sponge roller 801a is rotated in accordance with the rotation of the metal roller 803a, by the sponge roller 801a being pressed by the metal roller 803a. In the curl correcting portion 800, the conveyance force is produced by the sheet S being nipped by the sponge roller 801a and the metal roller 803a, and thereby the sheet S is conveyed downstream in the conveyance direction.

The upward correcting portion 840a is configured as described above. The downward correcting portion 840b has the same configuration as that of the upward correcting portion 840a except that the downward correcting portion 840b and the upward correcting portion 840a are inverted to each other in the vertical direction. Thus, the description of the upward correcting portion 840a will be substituted for the description of the downward correcting portion 840b, with a symbol “a” of a component of the upward correcting portion 840a being replaced with a symbol “b” of a corresponding component of the downward correcting portion 840b.

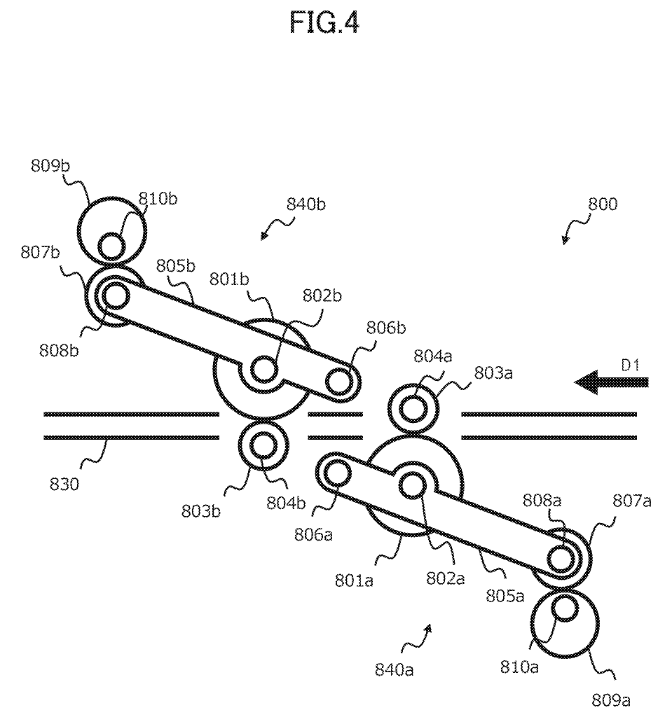

Next, a specific operation of the curl correcting portion 800 will be described. FIG. 4 is a cross-sectional view illustrating a default state of the curl correcting portion 800. As illustrated in FIG. 4, each of the upward correcting portion 840a and the downward correcting portion 840b is in a default state. In the default state, the pressing force between the sponge roller 801a and the metal roller 803a and between the sponge roller 801b and the metal roller 803b has a minimum value. Thus, in this state, even if the sheet S passes through the curl correcting portion 800, the sheet S is not forced to deform in the curl correcting portion 800.

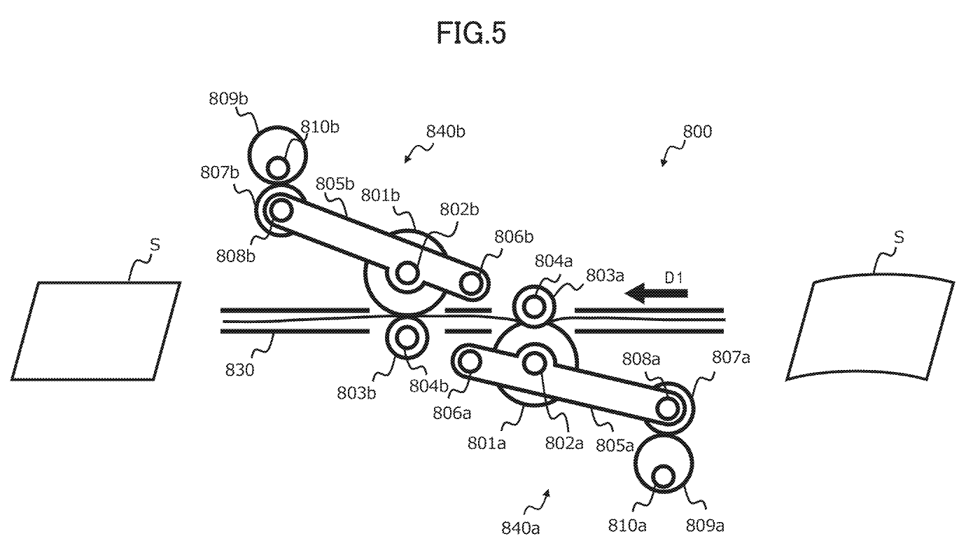

FIG. 5 is a cross-sectional view illustrating the curl correcting portion 800 in a state where a downward curl is being corrected. As illustrated in FIG. 5, in the curl correcting portion 800, in a case where a downward curl has occurred in the sheet S, the nip pressure between the sponge roller 801a and the metal roller 803a is changed to a predetermined value by controlling the angle of the cam 809a of the upward correcting portion 840a. As a result, in the upward correcting portion 840a, a curved nip that projects downward is formed. Thus, the sheet S that passes through the curl correcting portion 800 is forced to deform upward, so that the flat sheet S is output in a state where the downward curl is corrected.

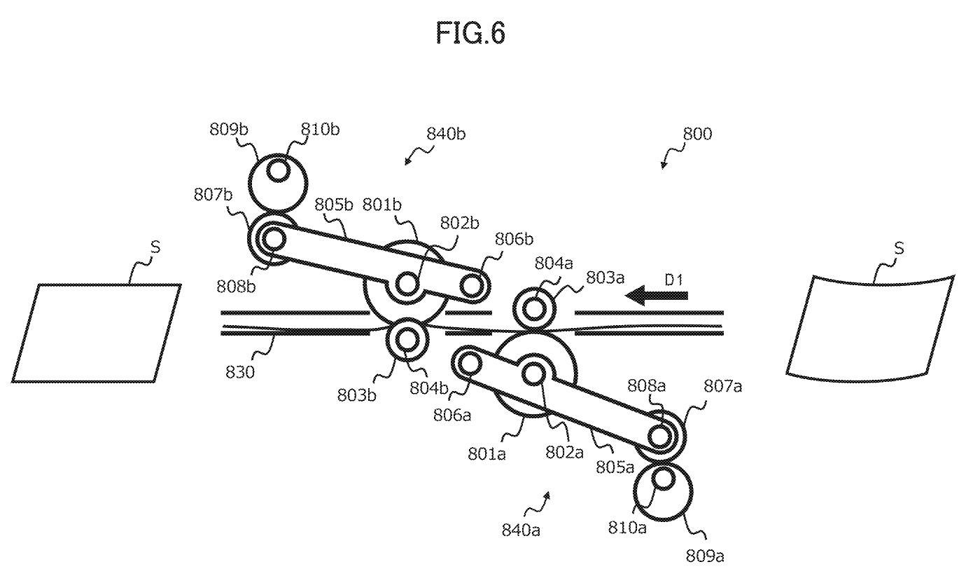

FIG. 6 is a cross-sectional view illustrating the curl correcting portion 800 in a state where an upward curl is being corrected. As illustrated in FIG. 6, in the curl correcting portion 800, in a case where an upward curl has occurred in the sheet S, the nip pressure between the sponge roller 801b and the metal roller 803b is changed to a predetermined value by controlling the angle of the cam 809b of the downward correcting portion 840b. As a result, in the downward correcting portion 840b, a curved nip that projects upward is formed. Thus, the sheet S that passes through the curl correcting portion 800 is forced to deform downward, so that the flat sheet S is output in a state where the upward curl is corrected.

Thus, in the curl correcting portion 800 of the first embodiment, the pressing force between the sponge roller 801a and the metal roller 803a of the upward correcting portion 840a, and the pressing force between the sponge roller 801b and the metal roller 803b of the downward correcting portion 840b are controlled. Each of the sponge rollers 801a and 801b serves as a first rotary member, and each of the metal rollers 803a and 803b serves as a second rotary member. That is, the amount of pressing performed by the metal roller 803a on the sponge roller 801a, or the amount of pressing performed by the metal roller 803b on the sponge roller 801b is adjusted. The amount of pressing performed by the metal roller on the sponge roller is a pressing amount by which the metal roller presses the sponge roller. In the other word, The amount of pressing performed by the metal roller on the sponge roller is an insertion amount by which the metal roller is inserted into the sponge roller. In this manner, the curl correcting portion 800 can correct the curl of the sheet S by forcing the sheet S to deform by a predetermined amount of curl in a predetermined curl direction so that the curl is cancelled. Note that one of the sponge roller and the metal roller has only to move with respect to the other. In addition, although the sponge rollers 801a and 801b and the metal rollers 803a and 803b are used in the curl correcting portion 800 of the first embodiment, the present disclosure is not limited to this. For example, the curl correcting portion 800 may use a belt (i.e., the first rotary member) stretched by and wound around a plurality of rollers, and a roller (i.e., the second rotary member). In this case, the belt and the roller form a nip portion for nipping and conveying the sheet S, and the roller abuts against the belt such that the belt is bent.

### Control Block

FIG. 7 is a control block diagram of the curl correcting apparatus 700 of the first embodiment. As illustrated in FIG. 7, the curl correcting apparatus 700 includes the controller 100 that is one example of a control portion. The controller 100 includes a CPU 101 and a memory 102, and controls each component of the curl correcting apparatus 700, depending on an instruction from the main-body control portion 9 (see FIG. 1). The controller 100 is one example of a control portion, and can adjust the amount of curl correction performed by the curl correcting portion 800. It can be said that the amount of curl correction performed by the curl correcting portion 800 is the amount of pressing performed by the metal roller 803a on the sponge roller 801a, or the amount of pressing performed by the metal roller 803b on the sponge roller 801b. The CPU 101 outputs an output signal to each electric component, depending on a detection signal sent from each of a below-described inline detection portion 630, a below-described stacked-bundle detection portion 880, and the main-body control portion 9, or on information stored in the memory 102, for operating the electric component at a desired timing and with a necessary amount of control. Examples of the electric component include the cam motor M1a, a cam motor M1b, and conveyance motors M2a and M2b. In addition, examples of the detection signal sent from the main-body control portion 9 include a detection signal from an environment sensor 840 disposed in the apparatus body 100A of the image forming apparatus 1. The environment sensor 840 detects any one or both of the temperature and the humidity of the outside of the apparatus body 100A. The memory 102 stores information data necessary for controlling each component, and the CPU 101 reads the information data stored in the memory 102 and writes information data to the memory 102.

### Curl Detection Portion

Next, a curl detection portion will be described with reference to FIG. 1 and FIGS. 8 to 18. The curl detection portion includes the inline detection portion 630 that serves as a first detection portion of the first embodiment, and the stacked-bundle detection portion 880 that serves as a second detection portion of the first embodiment.

### Inline Detection Portion

As illustrated in FIG. 1, in the first embodiment, the inline detection portion 630 is disposed downstream of the curl correcting portion 800 in the conveyance direction of the sheet S. The inline detection portion 630 measures the shape of the curl of the sheet S, as the shape of the sheet S that is being conveyed; and obtains the curl state.

If the inline detection portion 630 is disposed upstream of the curl correcting portion 800 in the conveyance direction, the curl correcting apparatus 700 will be required to additionally predict the effect of the curl correcting portion 800 on the shape of the curl of the sheet S, for predicting the shape of the curl of the sheet S that is finally discharged. In contrast, in a case where the inline detection portion 630 is disposed downstream of the curl correcting portion 800 in the conveyance direction, the effect of the curl correcting portion 800 on the shape of the curl of the sheet S is not included in parameters necessary for predicting the shape of the curl of the sheet S that is finally discharged.

As a result, the curl correcting apparatus 700 can increase the accuracy of the prediction performed for predicting the shape of the curl of the sheet S that is finally discharged.

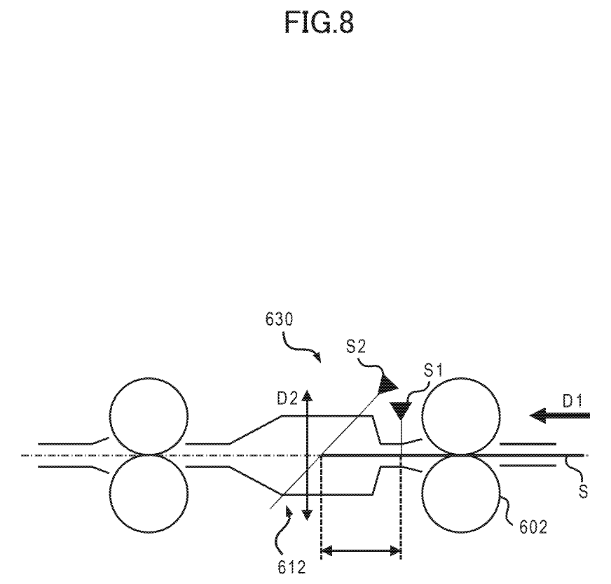

FIG. 8 is a cross-sectional view illustrating a configuration of the inline detection portion 630. As illustrated in FIG. 8, the inline detection portion 630 includes a first sensor S1 disposed downstream of a second conveyance-roller pair 602. The first sensor S1 is an optical sensor that detects the passage of edge portions (i.e., a leading edge and a trailing edge) of the sheet S. In addition, the inline detection portion 630 includes an opening portion 612 disposed downstream of the first sensor S1 in the conveyance direction. In the opening portion 612, the distance between an upper guide and a lower guide of the conveyance path is made larger than that of other conveyance paths. In addition, the inline detection portion 630 includes a second sensor S2 that is an optical sensor that detects the passage of edge portions (i.e., a leading edge and a trailing edge) of the sheet S. The second sensor S2 is inclined at a predetermined angle with respect to an orthogonal direction D2 orthogonal to both of a conveyance direction D1 and a width direction orthogonal to the conveyance direction D1.

The detection area of the second sensor S2 is set so that the second sensor S2 detects the sheet S upstream in the conveyance direction D1 as the sheet S moves upward in the orthogonal direction D2, and that the second sensor S2 detects the sheet S downstream in the conveyance direction D1 as the sheet S moves downward in the orthogonal direction D2. The distance between an upper guide and a lower guide of other conveyance paths is about 3mm, whereas the distance between an upper guide and a lower guide of the opening portion 612 is about 10 mm to 20 mm in the orthogonal direction D2. Thus, in the inline detection portion 630, when a curled sheet S passes through the opening portion 612, the opening portion 612 does not suppress the shape of the curl of the sheet S.

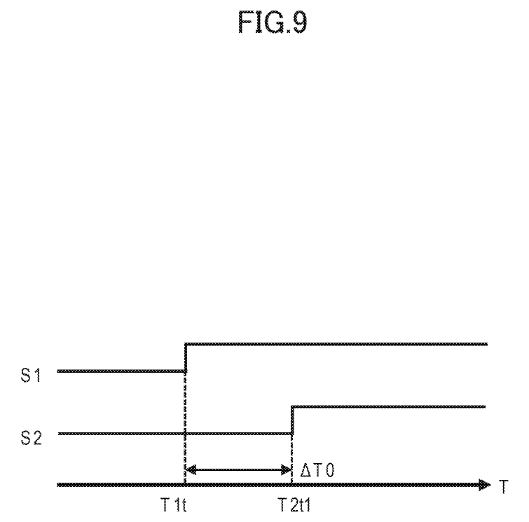

FIG. 9 is a diagram illustrating a change in output from the first sensor S1 and the second sensor S2 in a case where an uncurled sheet S illustrated in FIG. 8 is conveyed. As illustrated in FIG. 9, in the inline detection portion 630, if the sheet S is conveyed by the second conveyance-roller pair 602, the output signal from the first sensor S1 changes from Low to High (at a time T1t) when the leading edge of the sheet S passes through the detection area of the first sensor S1. After that, in the inline detection portion 630, the output signal from the second sensor S2 changes from Low to High (at a time T2t1) when the leading edge of the sheet S passes through the detection area of the second sensor S2. Thus, when the uncurled sheet S passes through the inline detection portion 630, the controller 100 obtains the difference ΔT0 (T2t1 - T1t) in detection timing between the detection timing of the first sensor S1 and the detection timing of the second sensor S2.

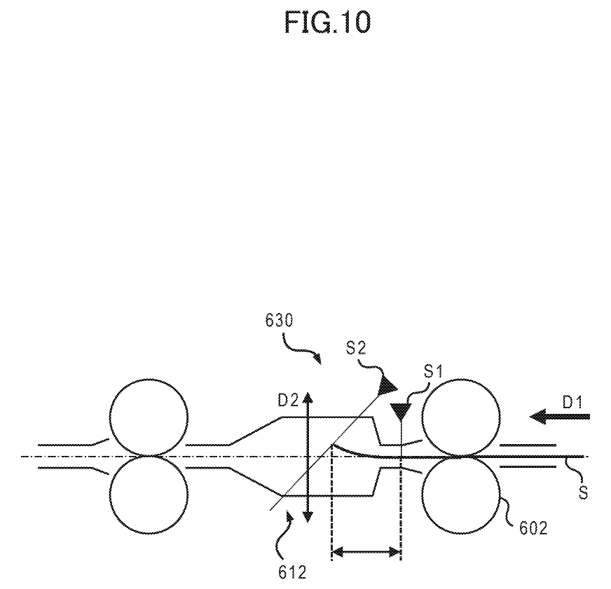

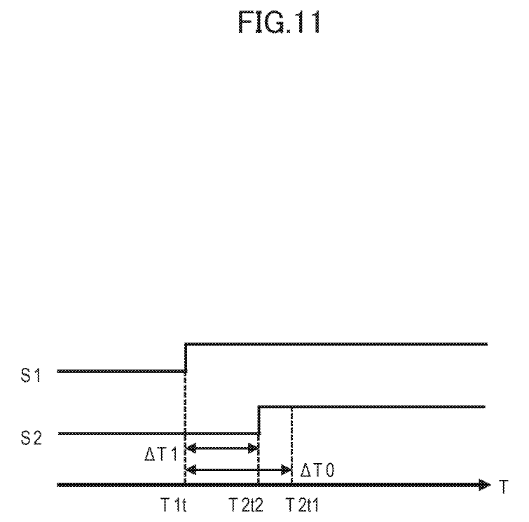

FIG. 10 is a cross-sectional view illustrating a case where a sheet S that is curled upward is conveyed to the inline detection portion 630. FIG. 11 is a diagram illustrating a change in output from the first sensor S1 and the second sensor S2 in the case where the sheet S illustrated in FIG. 10 and curled upward is conveyed. As illustrated in FIG. 10, the leading edge of the sheet S curled upward passes through an area of the opening portion 612 higher than the area of the opening portion 612 through which the uncurled sheet S passes. Thus, as illustrated in FIG. 11, the timing (i.e., a time T2t2) at which the second sensor S2 detects the leading edge of the sheet S and the output signal from the second sensor S2 changes from Low to High becomes earlier than the timing illustrated in FIG. 9, so that the difference ΔT1 in detection timing becomes smaller than the difference ΔT0 in detection timing.

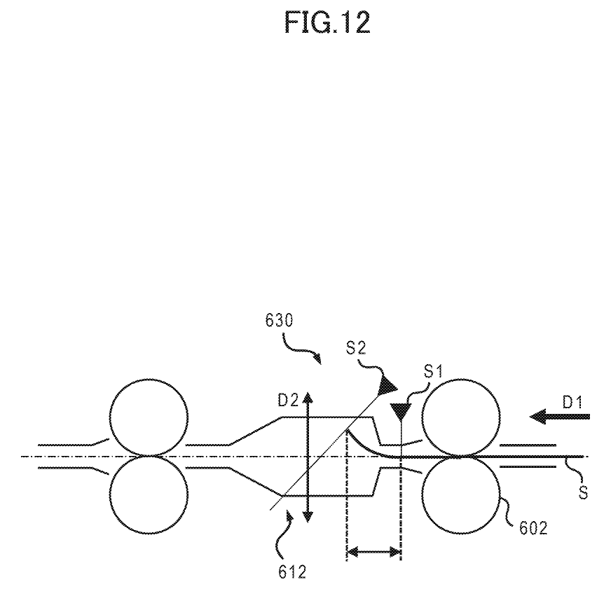

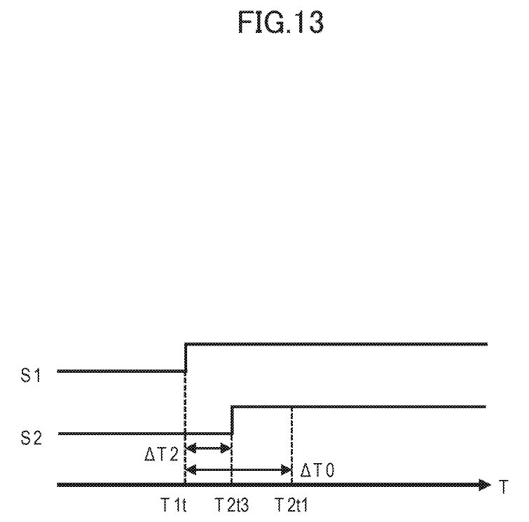

FIG. 12 is a cross-sectional view illustrating a case where a sheet S that is curled upward more than the sheet S illustrated in FIG. 10 is conveyed to the inline detection portion 630. FIG. 13 is a diagram illustrating a change in output from the first sensor S1 and the second sensor S2 in the case where the sheet S illustrated in FIG. 12 and curled upward is conveyed. As illustrated in FIG. 12, the leading edge of the sheet S curled upward more passes through an area of the opening portion 612 higher than the area of the opening portion 612 through which the curled sheet S illustrated in FIG. 10 passes. Thus, as illustrated in FIG. 13, the timing (i.e., a time T2t3) at which the second sensor S2 detects the leading edge of the sheet S and the output signal from the second sensor S2 changes from Low to High becomes earlier than the timing illustrated in FIG. 11, so that the difference ΔT2 in detection timing becomes smaller than the difference ΔT1 in detection timing.

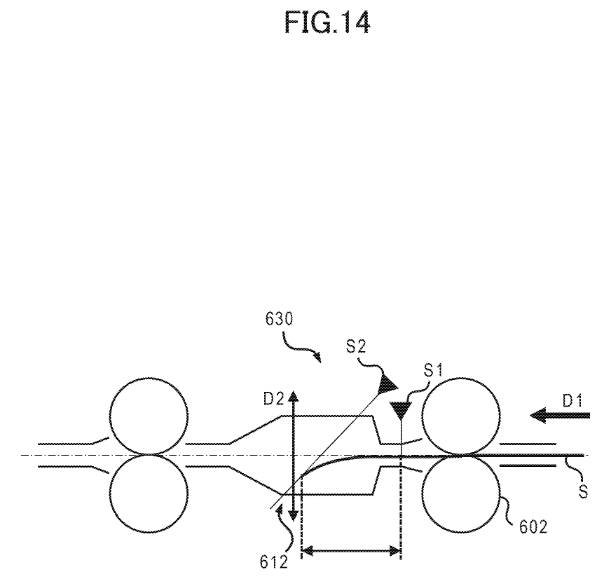

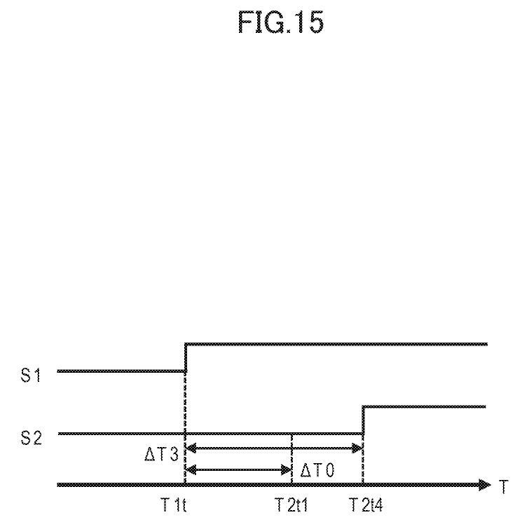

FIG. 14 is a cross-sectional view illustrating a case where a sheet S that is curled downward is conveyed to the inline detection portion 630. FIG. 15 is a diagram illustrating a change in output from the first sensor S1 and the second sensor S2 in the case where the sheet S illustrated in FIG. 14 and curled downward is conveyed. As illustrated in FIG. 14, the leading edge of the sheet S curled downward passes through an area of the opening portion 612 lower than the area of the opening portion 612 through which the uncurled sheet S passes. Thus, as illustrated in FIG. 15, the timing (i.e., a time T2t4) at which the second sensor S2 detects the leading edge of the sheet S and the output signal from the second sensor S2 changes from Low to High becomes later than the timing illustrated in FIG. 9, so that the difference ΔT3 in detection timing becomes larger than the difference ΔT0 in detection timing.

In this manner, the curl correcting apparatus 700 can evaluate the curl state of the leading edge of the sheet S conveyed to the inline detection portion 630, by evaluating the difference in detection timing between the first sensor S1 and the second sensor S2. In other words, the curl correcting apparatus 700 detects the curl state of the sheet S based on an elapsed time from detection of the edge of the sheet S by the first sensor S1 until detection of the edge of the sheet S by the second sensor S2, and the conveyance speed of the sheet S.

In this manner, the curl correcting apparatus 700 can detect the curl state of the sheet S conveyed, in a simple configuration in which the first sensor S1 and the second sensor S2 are used. Thus, the design cost can be suppressed from excessively increasing.

Note that in the curl correcting apparatus 700, since the parameter used for detecting the curl of the leading edge of the sheet S is the difference between detection timings at which the plurality of sensors detects the leading edge of the sheet S, the result of the curl detection will vary if the conveyance speed of the sheet S varies. Thus, in the curl correcting apparatus 700, the second conveyance-roller pair 602 is desired to have high accuracy and stability for reliably detecting the curl of the sheet conveyed by the inline detection portion 630.

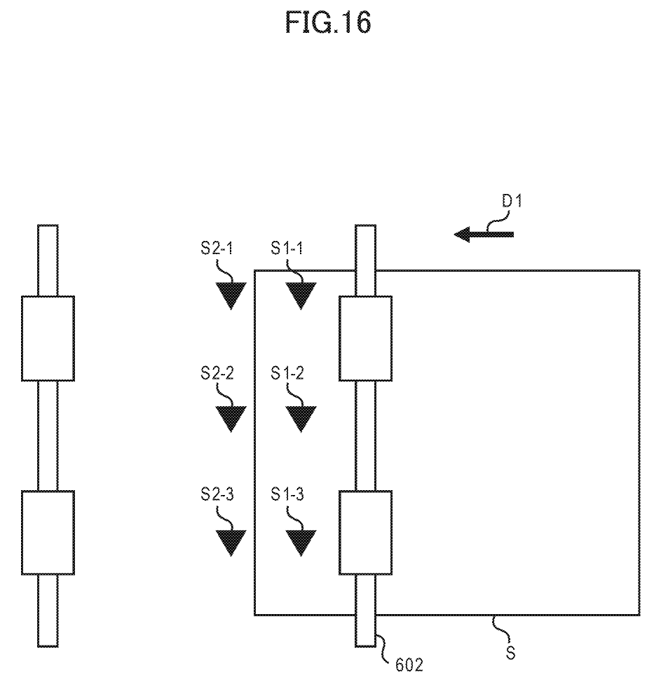

In the first embodiment, the single first sensor S1 and the single second sensor S2 are disposed in the sheet width direction. However, the present disclosure is not limited to this. FIG. 16 is a diagram illustrating a configuration in which a plurality of first sensors and a plurality of second sensors are disposed in the inline detection portion 630. As illustrated in FIG. 16, in the inline detection portion 630, a plurality of first sensors S1-1, S1-2, and S1-3 and a plurality of second sensors S2-1, S2-b, and S2-3 may be disposed in the width direction of the sheet S. In the inline detection portion 630 of the first embodiment, the first sensor S1 and the second sensor S2, each of which is an optical sensor that detects the passage of edge portions (i.e., a leading edge and a trailing edge) of the sheet S, are used. However, the present disclosure is not limited to this. For example, a CCD camera may be used as the inline detection portion 630. In this case, the CCD camera may capture an image of the sheet conveyed, and the shape of the curl of the sheet may be determined by performing the image processing on the image obtained.

### Stacked-Bundle Detection Portion

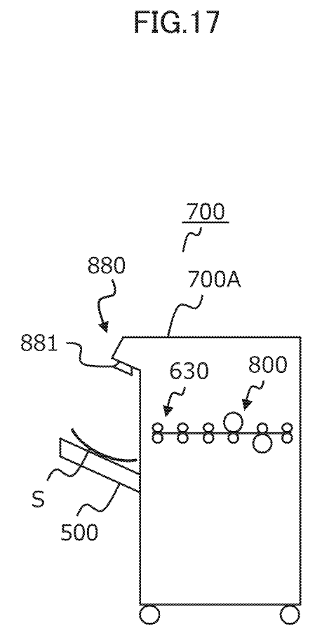

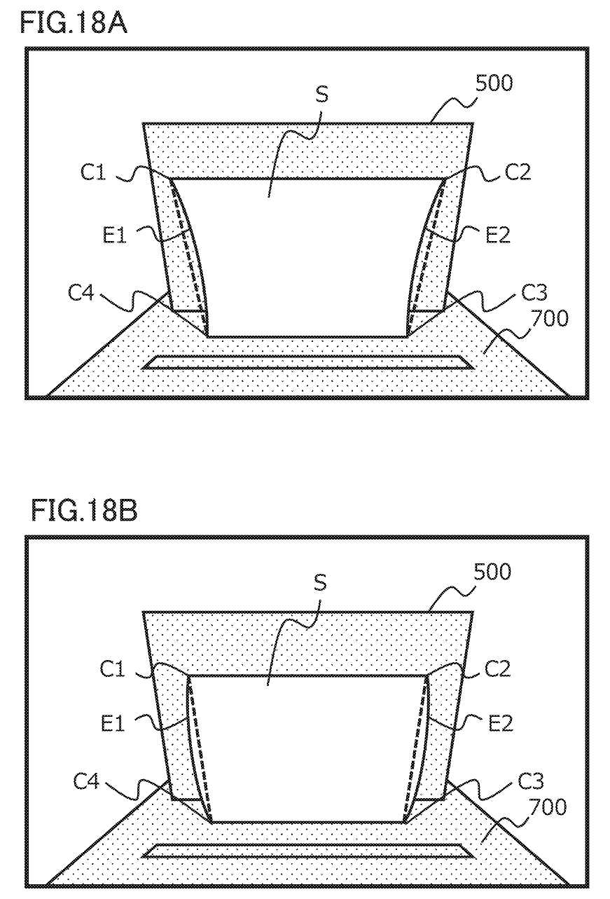

Next, the stacked-bundle detection portion 880 of the first embodiment that serves as a second detection portion will be described with reference to FIGS. 17 and 18. FIG. 17 is a cross-sectional view of the curl correcting apparatus 700.

As illustrated in FIG. 17, the stacked-bundle detection portion 880 includes a CCD camera 881. The CCD camera 881 is fixed to the curl correcting apparatus 700 at a position above the stacking tray 500. The stacking tray 500 serves as a stacking portion on which the discharged sheet S is stacked. That is, the stacked-bundle detection portion 880 causes the CCD camera 881 disposed above the stacking tray 500 to capture an image of an uppermost sheet of sheets S stacked on the stacking tray 500.

The stacked-bundle detection portion 880 measures the shape of the uppermost sheet of the stacked bundle formed by a plurality of sheets S stacked, and obtains the curl state. At a timing at which the stacked-bundle detection portion 880 performs the detection, the CCD camera 881 captures an image of the uppermost sheet of the stacked bundle stacked on the stacking tray 500 from above. After the capture of the image, the controller 100 detects sides (edges) and corners of the uppermost sheet by performing the image processing. As illustrated in FIGS. 18A and 18B, the controller 100 defines the detected four corners as C1, C2, C3, and C4 determined in this order from the upper left in the clockwise direction. In addition, the controller 100 defines an edge detected on the left side of the sheet S, as E1; and an edge detected on the right side of the sheet S, as E2. In addition, the controller 100 compares a straight line obtained by connecting C1 and C4, and the position of the edge E1 on the left side, and compares a straight line obtained by connecting C2 and C3, and the position of the edge E2 on the right side; and thereby determines the shape of the curl.

FIG. 18A is a diagram illustrating an image captured by the CCD camera 881 in a case where an upward curl is left in the uppermost sheet of a stacked bundle. As illustrated in FIG. 18A, if the detected edge E1 is inside with respect to the straight line C1-C4 and the detected edge E2 is inside with respect to the straight line C2-C3, the controller 100 determines that the upward curl is left in the uppermost sheet.

FIG. 18B is a diagram illustrating an image captured by the CCD camera 881 in a case where a downward curl is left in the uppermost sheet of a stacked bundle. As illustrated in FIG. 18B, if the detected edge E1 is outside with respect to the straight line C1-C4 and the detected edge E2 is outside with respect to the straight line C2-C3, the controller 100 determines that the downward curl is left in the uppermost sheet.

In this manner, the controller 100 performs the image processing on an image obtained by the CCD camera 881, and detects the curl state of the uppermost sheet S based on the degree of curvature at the side edges (i.e., edges) of the uppermost sheet S. In other words, the controller 100 performs the image processing on an image obtained by the CCD camera 881, and thereby can detect the curl state of the curl left in a sheet S that forms a stacked bundle. The curl state includes the direction and amount of the curl.

With this operation, the curl correcting apparatus 700 can detect the curl state of the uppermost sheet S stacked on the stacking tray 500; and correct the curl correction amount I, based on a result detected by the stacked-bundle detection portion 880. In this manner, the curl correcting apparatus 700 can achieve the appropriate amount of correction.

In the first embodiment, the CCD camera 881 that serves as an image capturing device is used as the stacked-bundle detection portion 880. However, non-contact distance sensors that can measure a plurality of positions on the sheet surface may be used. In this case, the curl state may be detected, based on the relative difference between the distance information from one sensor and the distance information from another. For example, the non-contact distance sensors are disposed above the stacking tray 500, and can measure distances from the non-contact distance sensors to the plurality of positions on a surface of the sheet.

### Control for Correcting Curl Correction Amount

As described above, in a case where the curl correction amount is set, it is required to predict the influence exerted on the curl state by the conditions (e.g., the environmental temperature, the environmental humidity, and the fixing temperature) that change continuously. In addition, it is also required to predict the air resistance that the sheet receives during the conveyance. To predict the air resistance that the sheet receives during the conveyance is to predict that the sheet will receive the air resistance during the conveyance of the sheet, that the sheet will be forced to receive wind (i.e., wind against the sheet that is produced by the running of the sheet) from the downstream side in the conveyance direction, and that the sheet will have a shape different from a shape of the sheet in a stationary state.

Thus, in a case where the curl correction amount is corrected based on only the result detected by the inline detection portion 630, it is difficult to perform the optimum prediction. In this case, the optimum curl correction amount is not applied to the curl state that is actually occurring, so that a slight curl will be left, not a little. Since the slight curl that is difficult to predict is left, curled sheets may be stacked on the stacking tray 500 one after another.

In this case, a newly stacked sheet is formed in accordance with the shape of the lower curled sheets. In this state, the shape of the curl of the following sheet to be stacked will also be affected. If it is repeated, the curl of the uppermost sheet of the stacked bundle will be increased accordingly, so that the shape of the stacked bundle will become more unstable as the number of stacked sheets increases. This problem occurs even if each of a plurality of stacked sheets has a slight curl. Thus, for preventing this problem, it is necessary to correct the curl of sheets so that the shape of the stacked bundle becomes stable.

Thus, in the image forming apparatus 1 that includes the curl correcting apparatus 700 of the first embodiment, the curl correcting apparatus 700 corrects the curl correction amount I, based on results detected by both detection portions of the inline detection portion 630 and the stacked-bundle detection portion 880. Hereinafter, the description will be made in detail for the control in which the curl correcting apparatus 700 corrects the curl correction amount I, based on results detected by both detection portions of the inline detection portion 630 and the stacked-bundle detection portion 880.

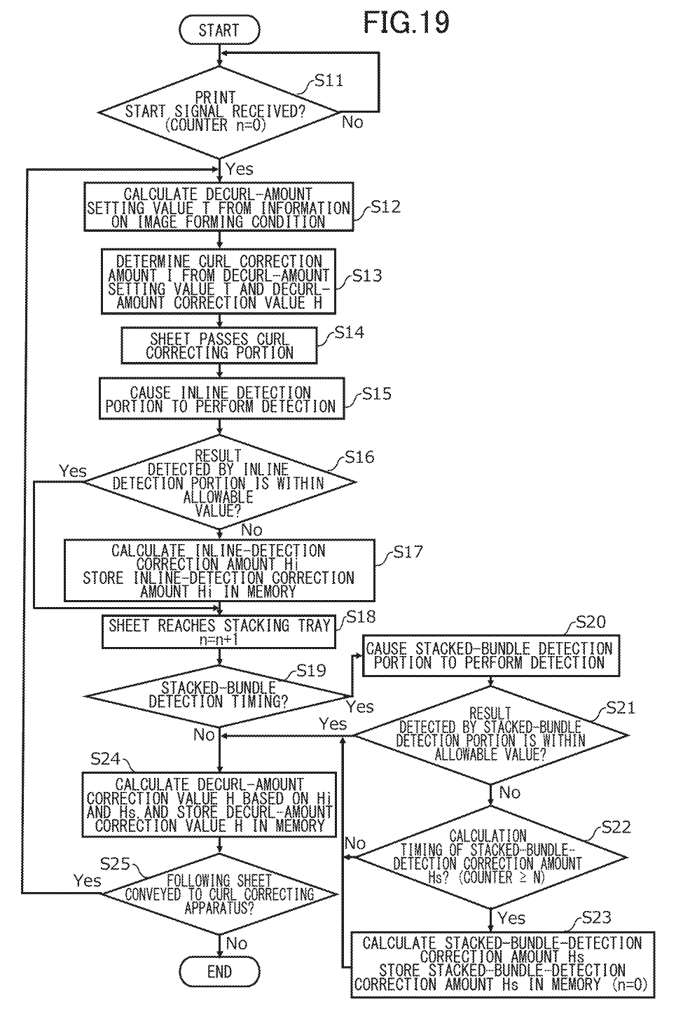

FIG. 19 is a flowchart illustrating a process executed by the CPU 101 of the controller 100, as control that the curl correcting apparatus 700 of the first embodiment performs for correcting the curl correction amount. The control illustrated in FIG. 19 and performed by the curl correcting apparatus 700 for correcting the curl correction amount is started after a user specifies a type of the sheet S on which the printing is to be performed, then sets a file for the printing and the number of copies, and then a print job (i.e., an image forming job) is started. The type of the sheet S specified by a user may be roughly set, for example, from among a regular paper sheet, a thick paper sheet, and a glossy paper sheet, or may be set from among brands of the sheet S. In addition, the file for the printing may be a series of image data and text data.

As illustrated in FIG. 19, the CPU 101 determines whether the CPU 101 has received a print start signal from the main-body control portion 9 (S11). In this process, the CPU 101 not only determines whether the CPU 101 has received a print start signal, but also sets zero to a counter n (n = 0) for determining the timing at which the CPU 101 calculates a correction amount (i.e., a stacked-bundle-detection correction amount Hs) based on the result detected by the stacked-bundle detection portion 880.

If the CPU 101 determines in Step S11 that the CPU 101 has not received the print start signal (S11: No), then the CPU 101 repeats Step S11 until the CPU 101 receives the print start signal. On the other hand, if the CPU 101 determines in Step S11 that the CPU 101 has received the print start signal (S11: Yes), then the CPU 101 calculates and sets a decurl-amount setting value T (S12). In this process, the CPU 101 calculates and sets the decurl-amount setting value T, based on information including a physical-property value that corresponds to the type of the sheet S that is set by a user, and image forming conditions such as the temperature and humidity of the outside air detected by the environment sensor 840 and an image to be printed.

Then the CPU 101 sets a curl correction amount I that is a curl correction amount, based on the decurl-amount setting value T and a decurl-amount correction value H (S13). In this process, the CPU 101 sets the curl correction amount I, based on the decurl-amount setting value T that is set in Step S12, and on the decurl-amount correction value H that is stored in the memory 102. In the curl correcting apparatus 700 of the first embodiment, a value of 0 is stored in the memory 102, as the initial value of the decurl-amount correction value H. The initial value is a value used before the curl detection is performed. Note that in the curl correcting apparatus 700, a predetermined value may be stored in the memory 102, as the initial value of the decurl-amount correction value H.

Then, in the curl correcting apparatus 700, the sheet S passes through the curl correcting portion 800 (S14), and the curl of the sheet S is corrected by the upward correcting portion 840a and the downward correcting portion 840b in which the curl correction amount I is set. Then the CPU 101 causes the inline detection portion 630 to perform the detection (S15). In this process, the CPU 101 detects the curl state for each of the sheets S conveyed to the inline detection portion 630.

Then the CPU 101 determines whether the curl state (detected by the inline detection portion 630) of the sheet S conveyed to the inline detection portion 630 is within an allowable value (S16). In this process, if the CPU 101 determines that the curl state of the sheet S is within the allowable value (S16: Yes), then the CPU 101 proceeds to Step S18 without executing Step S17.

On the other hand, if the CPU 101 determines that the curl state of the sheet S has exceeded the allowable value (S16: No), then the CPU 101 calculates an inline-detection correction amount Hi, stores the calculated result in the memory 102 (S17), and proceeds to Step S18. In Step S17, the CPU 101 calculates the inline-detection correction amount Hi that is a correction amount, based on the result detected by the inline detection portion 630; and stores the calculated result in the memory 102.

In Step S18, if a single sheet S is conveyed and reaches the stacking tray 500, the CPU 101 increments the counter n (n = n + 1) stored in the memory 102 (S18). Then the CPU 101 determines whether the timing (i.e., a stacked-bundle detection timing) at which the stacked-bundle detection portion 880 performs the detection has been reached (S19). In the first embodiment, as an example, the CPU 101 causes the stacked-bundle detection portion 880 to perform the detection each time 10 sheets are conveyed and reach the stacking tray 500.

In Step S19, if the CPU 101 determines that the timing at which the stacked-bundle detection portion 880 performs the detection has not been reached (S19: No), then the CPU 101 proceeds to Step S24. On the other hand, in Step S19, if the CPU 101 determines that the timing at which the stacked-bundle detection portion 880 performs the detection has been reached (S19: Yes), then the CPU 101 causes the stacked-bundle detection portion 880 to perform the detection (S20). In this process, the CPU 101 cause the CCD camera 881 to capture an image of the uppermost sheet of the stacked bundle stacked on the stacking tray 500, and performs the image processing on the image obtained; and thereby detects the curl state of the uppermost sheet S of the stacked bundle.

Then the CPU 101 determines whether the curl state of the uppermost sheet S of the stacked bundle, detected by the stacked-bundle detection portion 880, is within an allowable value (S21). In this process, if the CPU 101 determines that the curl state of the uppermost sheet S of the stacked bundle is within the allowable value (S21: Yes), then the CPU 101 proceeds to Step S24.

On the other hand, if the CPU 101 determines that the curl state of the uppermost sheet S of the stacked bundle has exceeded the allowable value (S21: No), then the CPU 101 determines whether a timing (i.e., a calculation timing) at which the CPU 101 calculates the stacked-bundle-detection correction amount Hs has been reached (S22). In this process, the CPU 101 determines whether the calculation timing has been reached, by determining whether the value of the counter n stored in the memory 102 is equal to or larger than a predetermined number N. In the first embodiment, a value of 50 is set to N.

That is, in a series of print job, in a case where the stacked-bundle-detection correction amount Hs is not set, the CPU 101 determines whether 50 or more sheets S have been stacked on the stacking tray 500. In addition, in a series of print job, in a case after the stacked-bundle-detection correction amount Hs is set, the CPU 101 determines whether 50 or more sheets S have been stacked on the stacking tray 500 since the stacked-bundle-detection correction amount Hs was set previously.

If the CPU 101 determines in Step S22 that the value of the counter n is smaller than N (n < N) (S22: No), then the CPU 101 proceeds to Step S24. On the other hand, if the CPU 101 determines in Step S22 that the value of the counter n is equal to or larger than N (n ≥ N) (S22: Yes), then the CPU 101 calculates the stacked-bundle-detection correction amount Hs, stores the calculated result in the memory 102 (S23), and proceeds to Step S24. In Step S23, the CPU 101 calculates the stacked-bundle-detection correction amount Hs that is a correction amount, based on the result detected by the stacked-bundle detection portion 880; and stores the calculated result in the memory 102. In addition, since the CPU 101 has set the stacked-bundle-detection correction amount Hs, the CPU 101 resets the counter n (n = 0) stored in the memory 102.

That is, in a first time from when the stacked-bundle-detection correction amount Hs stored in the memory 102 is changed last until the stacked-bundle-detection correction amount Hs is changed next, it is necessary to execute at least the steps S23, S24, and S25 and then the steps S12 to S22. In the present embodiment, since a value of 50 is set to N, the first time is a period of time in which at least 50 sheets are stacked on the stacking tray 500. On the other hand, a period of time from when the inline detection portion 630 detects, in Step S16, the curl state of a sheet that has exceeded the allowable value until the inline-detection correction amount Hi is changed in Step S17 is defined as a second time. In this case, the first time is longer than the second time.

In Step S24, the CPU 101 calculates the decurl-amount correction value H, based on the inline-detection correction amount Hi and the stacked-bundle-detection correction amount Hs; and stores the calculated result in the memory 102 (S24). By executing Step S24, the CPU 101 can set the decurl-amount correction value H, based on the inline-detection correction amount Hi and the stacked-bundle-detection correction amount Hs.

Thus, the controller 100 has the inline-detection correction amount Hi that serves as a first correction amount, and the stacked-bundle-detection correction amount Hs that serves as a second correction amount. The inline-detection correction amount Hi and the stacked-bundle-detection correction amount Hs are used when correcting the curl correction amount I.

Note that in the curl correcting apparatus 700, for a case where the CPU 101 executes Step S24 without executing Step S17, a predetermined value may be stored in the memory 102, as an initial value of the inline-detection correction amount Hi. In addition, in the curl correcting apparatus 700, for a case where the CPU 101 executes Step S24 without executing Step S23, a predetermined value may be stored in the memory 102, as an initial value of the stacked-bundle-detection correction amount Hs.

After executing Step S24, the CPU 101 determines whether a following sheet S is conveyed to the curl correcting apparatus 700 (S25). In this process, if the CPU 101 determines that a following sheet S is conveyed to the curl correcting apparatus 700 (S25: Yes), then the CPU 101 returns to Step S12. On the other hand, if the CPU 101 determines that no following sheet S is conveyed to the curl correcting apparatus 700 (S25: No), then the CPU 101 ends the control for correcting the curl correction amount in the curl correcting apparatus 700.

### Detailed Description of Correction of Curl Correction Amount

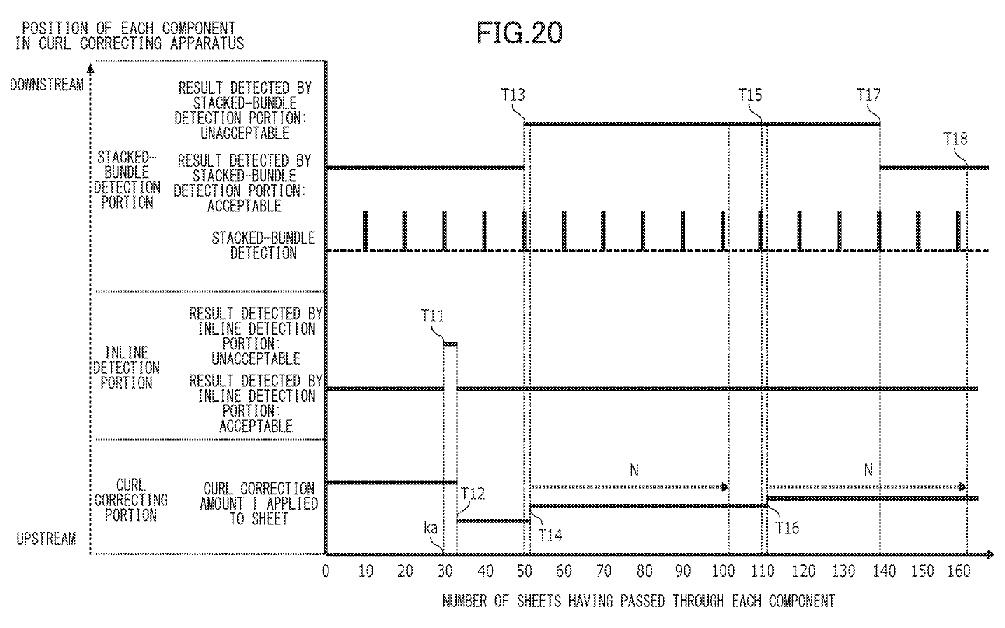

Next, a flow in which the curl correction amount I is corrected by executing the process illustrated in the flowchart of FIG. 19 will be described with reference to FIG. 20. FIG. 20 is a diagram illustrating a flow in which a plurality of sheets is conveyed to the curl correcting apparatus 700 and the curl correction amount I is corrected. In FIG. 20, the horizontal axis represents the number of sheets that pass through the curl correcting portion 800 and the inline detection portion 630, and that are stacked on the stacking tray 500. The vertical axis represents positions of the sheet S in the conveyance direction, at which corresponding components are disposed in the curl correcting apparatus 700. In addition, the vertical axis also represents a process executed by each component and a result of the process.

In the example illustrated in FIG. 20, the detection of the curl state of the sheet S by the inline detection portion 630 is performed each time a single sheet S is conveyed. In addition, the detection of the curl state of the uppermost sheet S of the stacked bundle performed by the stacked-bundle detection portion 880 is performed each time 10 sheets S are stacked. In addition, a value of 50 is set to N as the calculation timing of the stacked-bundle-detection correction amount Hs (N = 50). The value corresponds to the number of sheets S that is 50.

In the curl correcting apparatus 700, at a timing T11 at which sheets whose number is ka have been conveyed since the start of feeding sheets S, the CPU 101 determines in Step S16 illustrated in FIG. 19, that the result detected by the inline detection portion 630 has exceeded the allowable value (Unacceptable). Thus, the CPU 101, in Step S17 illustrated in FIG. 19, calculates the curl correction amount I, based on the inline-detection correction amount Hi calculated from the result detected by the inline detection portion 630 at the timing T11, and stores the calculated result in the memory 102.

In Step S24 illustrated in FIG. 19, the CPU 101 corrects the curl correction amount I, based on the inline-detection correction amount Hi. With this operation, in the curl correcting apparatus 700, the curl of the sheet S conveyed after the timing T11 is corrected by the upward correcting portion 840a and the downward correcting portion 840b in which the curl correction amount I is set based on the inline-detection correction amount Hi. Note that the timing at which the result detected by the inline detection portion 630 at the timing T11 is applied to the correction of the curl correction amount I is a timing at which one or more following sheets have been conveyed (the one or more following sheets are sheets that follow the sheet S detected by the inline detection portion 630). Thus, the timing T11 and a timing T12 are separated from each other by a period of time that corresponds to one or more sheets.

In the curl correcting apparatus 700, after the timing T12, the sheets S whose curl state is corrected by the curl correction amount I are stacked on the stacking tray 500 one after another. In the curl correcting apparatus 700, at a timing T13 at which 50 sheets have been conveyed, the CPU 101 determines in Step S21 illustrated in FIG. 19, that the result of the curl state of the sheet S detected by the stacked-bundle detection portion 880 has exceeded the allowable value (Unacceptable). Thus, the CPU 101, in Step S23 illustrated in FIG. 19, stores the stacked-bundle-detection correction amount Hs calculated from the result detected by the stacked-bundle detection portion 880 at the timing T13, in the memory 102. Then, in Step S24 illustrated in FIG. 19, the CPU 101 calculates the curl correction amount I, based on the inline-detection correction amount Hi and the stacked-bundle-detection correction amount Hs; and stores the calculated result in the memory 102.

In this manner, in the curl correcting apparatus 700, the curl correction amount I corrected based on the inline-detection correction amount Hi and the stacked-bundle-detection correction amount Hs is set. In addition, in the curl correcting apparatus 700, the curl of the sheet S conveyed after the timing T13 is corrected by the upward correcting portion 840a and the downward correcting portion 840b in which the curl correction amount I is set.

Note that the timing at which the result detected by the stacked-bundle detection portion 880 at the timing T13 is applied to the correction of the curl correction amount I is a timing at which one or more following sheets have been conveyed (the one or more following sheets are sheets that follow the sheet S detected by the stacked-bundle detection portion 880). Thus, the timing T13 and a timing T14 are separated from each other by a period of time that corresponds to one or more sheets.

In the curl correcting apparatus 700, even after the timing T14, the sheets S are stacked on the stacking tray 500 one after another, and the stacked-bundle detection portion 880 performs the detection each time 10 sheets S are stacked. In a period of time from the timing T14 to a timing at which N (i.e., 50) sheets S are stacked, the CPU 101 proceeds from Step S22 to Step S24 illustrated in FIG. 19, even if the CPU 101 determines that the result detected by the stacked-bundle detection portion 880 has exceeded the allowable value (Unacceptable). Thus, in the curl correcting apparatus 700, in the period of time from the timing T14 to the timing at which N (i.e., 50) sheets S are stacked, the correction of the curl correction amount I based on the stacked-bundle-detection correction amount Hs is not performed even if the result detected by the stacked-bundle detection portion 880 has exceeded the allowable value.

After the timing at which N (i.e., 50) sheets S are stacked after the timing T14, the CPU 101 proceeds from Step S22 to Step S23 illustrated in FIG. 19, if the CPU 101 determines that the result detected by the stacked-bundle detection portion 880 has exceeded the allowable value (Unacceptable). Thus, the CPU 101, in Step S23 illustrated in FIG. 19, stores the stacked-bundle-detection correction amount Hs calculated from the result detected by the stacked-bundle detection portion 880 at the timing T15, in the memory 102. Then, in Step S24 illustrated in FIG. 19, the CPU 101 calculates the curl correction amount I, based on the inline-detection correction amount Hi and the stacked-bundle-detection correction amount Hs; and stores the calculated result in the memory 102.

In this manner, in the curl correcting apparatus 700, the curl correction amount I corrected based on the inline-detection correction amount Hi and the stacked-bundle-detection correction amount Hs is set. In addition, in the curl correcting apparatus 700, the curl of the sheet S conveyed after the timing T15 is corrected by the upward correcting portion 840a and the downward correcting portion 840b in which the curl correction amount I is set.

Note that the timing at which the result detected by the stacked-bundle detection portion 880 at the timing T15 is applied to the correction of the curl correction amount I is a timing at which one or more following sheets have been conveyed (the one or more following sheets are sheets that follow the sheet S detected by the stacked-bundle detection portion 880). Thus, the timing T15 and a timing T16 are separated from each other by a period of time that corresponds to one or more sheets.

In the curl correcting apparatus 700, even after the timing T16, the sheets S are stacked on the stacking tray 500 one after another, and the stacked-bundle detection portion 880 performs the detection each time 10 sheets S are stacked. In a period of time from the timing T16 to a timing at which N (i.e., 50) sheets have been stacked, the CPU 101 proceeds from Step S22 to Step S24 illustrated in FIG. 9, even if the result detected by the stacked-bundle detection portion 880 has exceeded the allowable value (Unacceptable). Thus, in the curl correcting apparatus 700, in a period of time from the timing T16 to a timing at which N (i.e., 50) sheets S are stacked, the correction of the curl correction amount I based on the stacked-bundle-detection correction amount Hs is not performed even if the result detected by the stacked-bundle detection portion 880 has exceeded the allowable value (Unacceptable).

In the curl correcting apparatus 700, a newly stacked sheet is supported in a shape corresponding to the curl state of sheets already stacked on the stacking tray 500. That is, a sheet newly stacked on the stacking tray 500 is affected by the curl state of sheets stacked previously on the stacking tray 500.

In the example illustrated in FIG. 20, a timing T17 is a timing at which more than 10 sheets have been conveyed (the stacked-bundle detection portion 880 performs the detection at a timing at which 10 sheets have been conveyed), and which is earlier than the calculation timing (which corresponds to 50 or more sheets) of the stacked-bundle-detection correction amount Hs. In the curl correcting apparatus 700, there is a timing, such as the timing T17, at which the result detected by the stacked-bundle detection portion 880 is within the allowable value (Acceptable) before the calculation timing is reached. Thus, in the curl correcting apparatus 700, if the curl correction amount I is corrected, before the calculation timing for calculating the stacked-bundle-detection correction amount Hs is reached, by calculating the stacked-bundle-detection correction amount Hs based on the result detected by the stacked-bundle detection portion 880, the overcorrection may be caused and the shape of the stacked bundle may become unstable.

For this reason, in the curl correcting apparatus 700 of the first embodiment, the number of sheets S corrected with the curl correction amount I corrected based on the stacked-bundle-detection correction amount Hs is set at N (i.e., 50). The N (i.e., 50) number of sheets S are stacked without affecting the shape of the stacked bundle. That is, if the number of sheets stacked on the stacking tray 500 is smaller than N, the curl correcting apparatus 700 does not perform the update of the curl correction amount I, which is performed based on the stacked-bundle-detection correction amount Hs.

In the example illustrated in FIG. 20, in the curl correcting apparatus 700, at a timing T18 at which 50 sheets have been stacked since the timing T16, the result detected by the inline detection portion 630 is within the allowable value (Acceptable). In addition, in the curl correcting apparatus 700, at the timing T18, the result detected by the stacked-bundle detection portion 880 is within the allowable value (Acceptable). Thus, in the curl correcting apparatus 700, at the timing T18, the curl correction amount I is not corrected, so that the curl correction amount I that was set at the timing T15 is kept.

### Summary of First Embodiment

As described above, the curl correcting apparatus 700 of the first embodiment causes the inline detection portion 630 to detect the curl state for each of the sheets S conveyed, and calculates the inline-detection correction amount Hi in a case where the curl state has exceeded the allowable value (Unacceptable). In addition, the curl correcting apparatus 700 detects the curl state of the uppermost sheet S of a stacked bundle stacked on the stacking tray 500, and calculates the stacked-bundle-detection correction amount Hs in a case where the curl state has exceeded the allowable value (Unacceptable). The curl correcting apparatus 700 sets the curl correction amount I, based on the inline-detection correction amount Hi and the stacked-bundle-detection correction amount Hs. That is, even in a case where a certain level of curl correction effect cannot be obtained due to the difference in production lot of the sheet S, the change in water content of the sheet S, variations in production of the curl correcting portion 800, and the like, the curl correcting apparatus 700 feed-backs the correction amount of the curl correction amount I, based on the results detected by the two detection portions.

With this configuration, in the curl correcting apparatus 700, the sheet S can be stably stacked on the stacking tray 500, and the problems, such as the failure of stacking, the fall of the bundle in the conveyance, the failure of feeding in a post-processing apparatus, the failure of alignment, and the failure of stapling, can be suppressed.

In addition, the curl correcting apparatus 700 of the first embodiment calculates the decurl-amount setting value T, based on a physical-property value of the sheet S that is used by the image forming engine 513 for forming an image and that is set by a user, and on information such as the temperature and humidity of the outside air detected by the environment sensor 840 and an image to be printed. In addition, the curl correcting apparatus 700 sets an initial value of the curl correction amount I in the initial state in which the printing is started, by using the decurl-amount setting value T.

Thus, the curl correcting apparatus 700 can reduce the number of repetitions of feed-backing the correction amount (the repetitions are performed in a period of time from when the curl state is initially detected until when the correction amount converges to an optimum curl correction amount I), with respect to the number of repetitions in a case where the decurl-amount setting value T is not used.

The physical-property value of the sheet S that corresponds to a type of the sheet S and that is set by a user, and the information such as the temperature and humidity of the outside air detected by the environment sensor 840 and an image to be printed constitute the information on the image forming condition. The information of the image forming condition is used for image formation by the image forming engine 513 which includes the image forming portions PY, PM, PC, and PK. In addition, the information on the physical-property value of the sheet S that corresponds to a type of the sheet S, and that is set by a user constitutes the information on the type of the sheet S on which an image is to be formed; the information on the temperature and humidity of the outside air detected by the environment sensor 840 constitutes the information on the external environment; and the information on a print image constitutes the information on an image to be formed on the sheet.

In the curl correcting apparatus 700 of the first embodiment, the stacked-bundle detection portion 880 performs the detection each time 10 sheets are stacked on the stacking tray 500. The number (i.e., 10) of sheets S serves as a first set number of sheets.

Thus, the curl correcting apparatus 700 can be suppressed from causing the stacked-bundle detection portion 880 to perform the detection each time a single sheet S is stacked, in a state where the sheets are stacked one after another. As a result, it can be suppressed that the detection result becomes unstable and the curl correction amount I is corrected excessively or insufficiently.

In addition, in a case where the result detected by the stacked-bundle detection portion 880 is within the allowable value (Acceptable), the curl correcting apparatus 700 of the first embodiment does not set the stacked-bundle-detection correction amount Hs. In addition, in a case where the result detected by the stacked-bundle detection portion 880 has exceeded the allowable value (Unacceptable) and the number of the sheets S stacked on the stacking tray 500 has already reached N (i.e., 50) larger than 10, the curl correcting apparatus 700 sets the stacked-bundle-detection correction amount Hs. On the other hand, in a case where the result detected by the stacked-bundle detection portion 880 has exceeded the allowable value (Unacceptable) and the number of the sheets S stacked on the stacking tray 500 has not reached N (i.e., 50), the curl correcting apparatus 700 does not set the stacked-bundle-detection correction amount Hs.

With this operation, the curl correcting apparatus 700 can correct the curl correction amount I, based on the stacked-bundle-detection correction amount Hs, in consideration of the influence that the curl state of sheets S previously stacked on the stacking tray 500 exerts on a newly stacked sheet. As a result, the curl correcting apparatus 700 can be suppressed from overcorrecting the curl correction amount I by using the stacked-bundle-detection correction amount Hs and from making the shape of the stacked bundle unstable.

The result detected by the inline detection portion 630 serves as a first detection result, and the result detected by the stacked-bundle detection portion 880 serves as a second detection result. In addition, the allowable value used for determining the result detected by the stacked-bundle detection portion 880 serves as a threshold, and if the result detected by the stacked-bundle detection portion 880 is within the allowable value (i.e., the threshold), the curl correcting apparatus 700 does not set the stacked-bundle-detection correction amount Hs. In addition, the number N (i.e., 50) of sheets S stacked on the stacking tray 500 and corresponding to the timing at which the stacked-bundle-detection correction amount Hs is calculated in a case where the result detected by the stacked-bundle detection portion 880 has exceeded the allowable value (i.e., the threshold) serves as a second set number of sheets.

### Second Embodiment

Next, a curl correcting apparatus 700 of a second embodiment will be described. In the curl correcting apparatus 700 of the second embodiment, the controller 100 does not communicate with the main-body control portion 9 of the image forming apparatus 1, and the detection of the curl of the sheet S and the correction of the curl correction amount I are performed by the curl correcting apparatus 700 alone. In this point, the curl correcting apparatus 700 of the second embodiment differs from the curl correcting apparatus 700 of the above-described first embodiment. Since the other configuration of the second embodiment is the same as that of the first embodiment, a component identical to a component of the first embodiment is given an identical symbol, a control process identical to a control process of the first embodiment is given an identical step number, and the description thereof will be omitted.

### Control Block

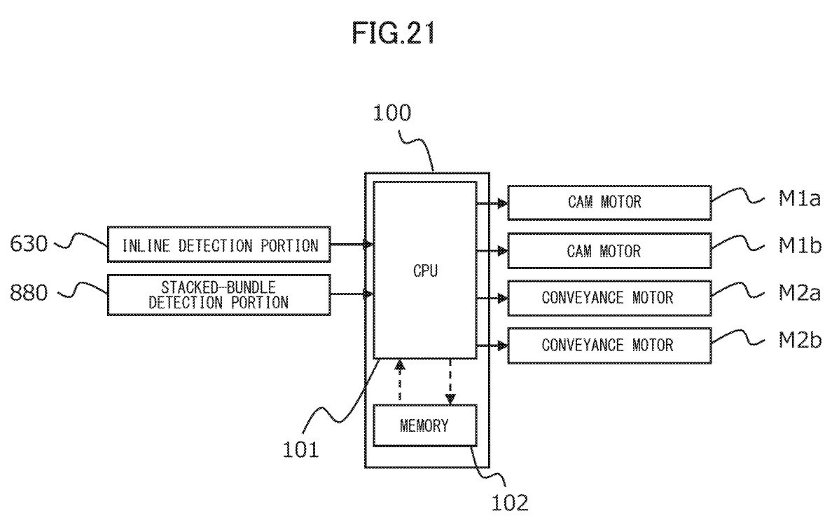

FIG. 21 is a control block diagram of the curl correcting apparatus 700 of the second embodiment. As illustrated in FIG. 21, the curl correcting apparatus 700 includes the controller 100 that is one example of a control portion. The controller 100 includes the CPU 101 and the memory 102, and controls each component of the curl correcting apparatus 700 by loading a program stored in the memory 102 and executing the program. The controller 100 is one example of a control portion, and can adjust the amount of curl correction performed by the curl correcting portion 800. The CPU 101 outputs an output signal to each electric component, depending on a detection signal sent from each of the inline detection portion 630 and the stacked-bundle detection portion 880 or on information stored in the memory 102, for operating the electric component at a desired timing and with a necessary amount of control. Examples of the electric component include the cam motors M1a and M1b, and the conveyance motors M2a and M2b. The memory 102 stores information data necessary for controlling each component, and the CPU 101 reads the information data stored in the memory 102 and writes information data to the memory 102.

### Control for Correcting Curl Correction Amount

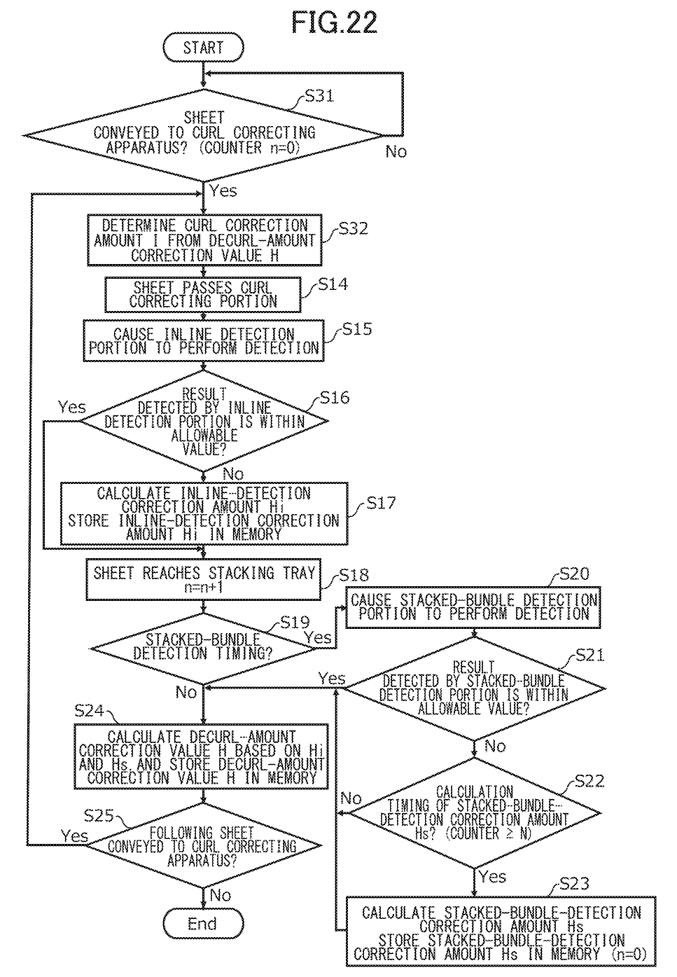

FIG. 22 is a flowchart illustrating a process executed by the CPU 101 of the controller 100, as control that the curl correcting apparatus 700 of the second embodiment performs for correcting the curl correction amount. The control illustrated in FIG. 22 and performed by the curl correcting apparatus 700 for correcting the curl correction amount is started if the conveyance of the sheet S to the curl correcting apparatus 700 is detected.

As illustrated in FIG. 22, the CPU 101 determines whether the sheet S is conveyed to the curl correcting apparatus 700 (S31). In this process, the CPU 101 determines whether the sheet S is conveyed to the curl correcting apparatus 700. In addition, in this process, the CPU 101 sets zero to the counter n (n = 0) for determining the timing at which the CPU 101 calculates a correction amount (i.e., the stacked-bundle-detection correction amount Hs) based on the result detected by the stacked-bundle detection portion 880.

If the CPU 101 determines in Step S31 that the sheet S is not conveyed to the curl correcting apparatus 700 (S31: No), then the CPU 101 repeats Step S31 until the CPU 101 determines that the sheet S is conveyed to the curl correcting apparatus 700. On the other hand, if the CPU 101 determines in Step S31 that the sheet S is conveyed to the curl correcting apparatus 700 (S31: Yes), then the CPU 101 sets the curl correction amount I, which is a curl correction amount, based on the decurl-amount correction value H (S32). In this process, the CPU 101 sets the curl correction amount I, based on the decurl-amount correction value H stored in the memory 102. In the curl correcting apparatus 700 of the second embodiment, a value of 0 is stored in the memory 102, as the initial value of the decurl-amount correction value H. The initial value is a value used before the curl detection is performed. Note that in the curl correcting apparatus 700, a predetermined value may be stored in the memory 102, as the initial value of the decurl-amount correction value H. After executing Step S32, the CPU 101 proceeds to Step S14.

After executing Step S24, the CPU 101 determines whether a following sheet S is conveyed to the curl correcting apparatus 700 (S25). In this process, if the CPU 101 determines that a following sheet S is conveyed to the curl correcting apparatus 700 (S25: Yes), then the CPU 101 returns to Step S32. On the other hand, if the CPU 101 determines that no following sheet S is conveyed to the curl correcting apparatus 700 (S25: No), then the CPU 101 ends the control for correcting the curl correction amount in the curl correcting apparatus 700.

### Detailed Description of Correction of Curl Correction Amount

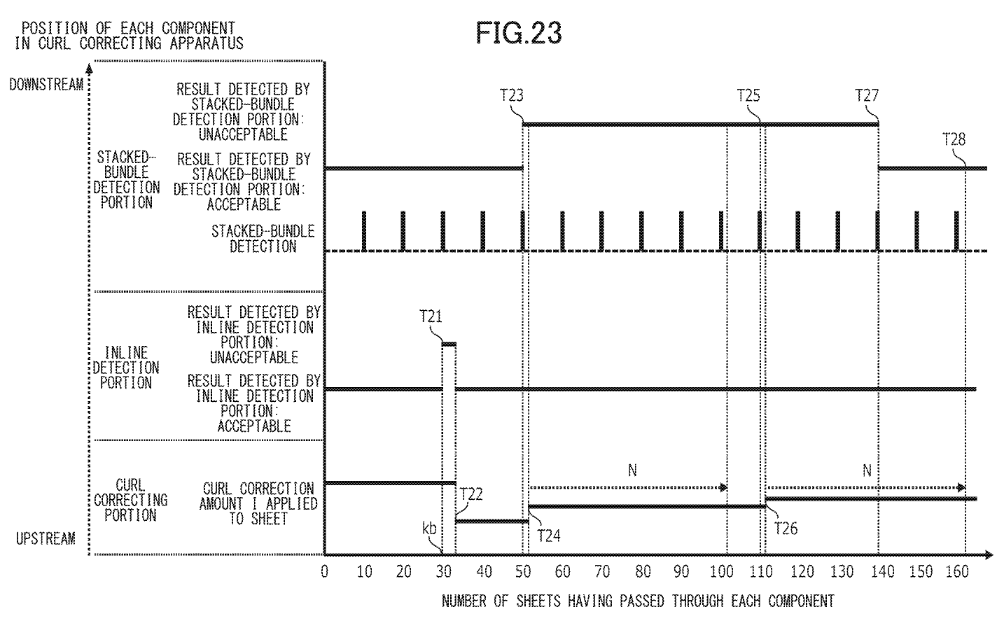

Next, a flow in which the curl correction amount I is corrected by executing the process illustrated in FIG. 22 will be described with reference to FIG. 23. FIG. 23 is a diagram illustrating a flow in which a plurality of sheets is conveyed to the curl correcting apparatus 700 and the curl correction amount I is corrected. In FIG. 23, the horizontal axis represents the number of sheets that pass through the curl correcting portion 800 and the inline detection portion 630, and that are stacked on the stacking tray 500. The vertical axis represents positions of the sheet S in the conveyance direction, at which corresponding components are disposed in the curl correcting apparatus 700. In addition, the vertical axis also represents a process executed by each component and a result of the process.

In the example illustrated in FIG. 23, in the curl correcting apparatus 700, the detection of the curl state of the sheet S (conveyed in the curl correcting apparatus 700) performed by the inline detection portion 630 is performed each time a single sheet S is conveyed. In addition, the detection of the curl state of the uppermost sheet S of the stacked bundle performed by the stacked-bundle detection portion 880 is performed each time 10 sheets S are stacked. In addition, a value of 50 is set as the calculation timing of the stacked-bundle-detection correction amount Hs (N = 50). The value corresponds to the number of sheets S that is 50.

In the curl correcting apparatus 700, at a timing T21 at which sheets whose number is kb have been conveyed since the start of feeding sheets S, the CPU 101 determines in Step S16 illustrated in FIG. 22, that the result detected by the inline detection portion 630 has exceeded the allowable value (Unacceptable). Thus, the CPU 101, in Step S17 illustrated in FIG. 22, calculates the curl correction amount I, based on the inline-detection correction amount Hi calculated from the result detected by the inline detection portion 630 at the timing T21, and stores the calculated result in the memory 102.

In Step S24 illustrated in FIG. 22, the CPU 101 corrects the curl correction amount I, based on the inline-detection correction amount Hi. With this operation, in the curl correcting apparatus 700, the curl of the sheet S conveyed after the timing T21 is corrected by the upward correcting portion 840a and the downward correcting portion 840b in which the curl correction amount I is set based on the inline-detection correction amount Hi. Note that the timing at which the result detected by the inline detection portion 630 at the timing T21 is applied to the correction of the curl correction amount I is a timing at which one or more following sheets have been conveyed (the one or more following sheets are sheets that follow the sheet S detected by the inline detection portion 630). Thus, the timing T21 and a timing T22 are separated from each other by a period of time that corresponds to one or more sheets.

In the curl correcting apparatus 700, after the timing T22, the sheets S whose curl state is corrected by the curl correction amount I are stacked on the stacking tray 500 one after another. In the curl correcting apparatus 700, at a timing T23 at which 50 sheets have been conveyed, the CPU 101 determines in Step S21 illustrated in FIG. 22, that the result of the curl state of the sheet S detected by the stacked-bundle detection portion 880 has exceeded the allowable value (Unacceptable). Thus, the CPU 101, in Step S23 illustrated in FIG. 22, stores the stacked-bundle-detection correction amount Hs calculated from the result detected by the stacked-bundle detection portion 880 at the timing T23, in the memory 102. Then, in Step S24 illustrated in FIG. 22, the CPU 101 calculates the curl correction amount I, based on the inline-detection correction amount Hi and the stacked-bundle-detection correction amount Hs; and stores the calculated result in the memory 102.

In this manner, in the curl correcting apparatus 700, the curl correction amount I corrected based on the inline-detection correction amount Hi and the stacked-bundle-detection correction amount Hs is set. In addition, in the curl correcting apparatus 700, the curl of the sheet S conveyed after the timing T23 is corrected by the upward correcting portion 840a and the downward correcting portion 840b in which the curl correction amount I is set.

Note that the timing at which the result detected by the stacked-bundle detection portion 880 at the timing T23 is applied to the correction of the curl correction amount I is a timing at which one or more following sheets have been conveyed (the one or more following sheets are sheets that follow the sheet S detected by the stacked-bundle detection portion 880). Thus, the timing T23 and a timing T24 are separated from each other by a period of time that corresponds to one or more sheets.

In the curl correcting apparatus 700, even after the timing T24, the sheets S are stacked on the stacking tray 500 one after another, and the stacked-bundle detection portion 880 performs the detection each time 10 sheets S are stacked. In a period of time from the timing T24 to a timing at which N (i.e., 50) sheets S are stacked, the CPU 101 proceeds from Step S22 to Step S24 illustrated in FIG. 22, even if the CPU 101 determines that the result detected by the stacked-bundle detection portion 880 has exceeded the allowable value (Unacceptable). Thus, in the curl correcting apparatus 700, in the period of time from the timing T24 to the timing at which N (i.e., 50) sheets S are stacked, the correction of the curl correction amount I based on the stacked-bundle-detection correction amount Hs is not performed even if the result detected by the stacked-bundle detection portion 880 has exceeded the allowable value.

After the timing at which N (i.e., 50) sheets S are stacked after the timing T24, the CPU 101 proceeds from Step S22 to Step S23 illustrated in FIG. 22, if the CPU 101 determines that the result detected by the stacked-bundle detection portion 880 has exceeded the allowable value (Unacceptable). Thus, the CPU 101, in Step S23 illustrated in FIG. 22, stores the stacked-bundle-detection correction amount Hs calculated from the result detected by the stacked-bundle detection portion 880 at the timing T25, in the memory 102. Then, in Step S24 illustrated in FIG. 22, the CPU 101 calculates the curl correction amount I, based on the inline-detection correction amount Hi and the stacked-bundle-detection correction amount Hs; and stores the calculated result in the memory 102.

In this manner, in the curl correcting apparatus 700, the curl correction amount I corrected based on the inline-detection correction amount Hi and the stacked-bundle-detection correction amount Hs is set. In addition, in the curl correcting apparatus 700, the curl of the sheet S conveyed after the timing T25 is corrected by the upward correcting portion 840a and the downward correcting portion 840b in which the curl correction amount I is set.

Note that the timing at which the result detected by the stacked-bundle detection portion 880 at the timing T25 is applied to the correction of the curl correction amount I is a timing at which one or more following sheets have been conveyed (the one or more following sheets are sheets that follow the sheet S detected by the stacked-bundle detection portion 880). Thus, the timing T25 and a timing T26 are separated from each other by a period of time that corresponds to one or more sheets.

In the curl correcting apparatus 700, even after the timing T26, the sheets S are stacked on the stacking tray 500 one after another, and the stacked-bundle detection portion 880 performs the detection each time 10 sheets S are stacked. In a period of time from the timing T26 to a timing at which N (i.e., 50) sheets S are stacked, the CPU 101 proceeds from Step S22 to Step S24 illustrated in FIG. 22, even if the CPU 101 determines that the result detected by the stacked-bundle detection portion 880 has exceeded the allowable value (Unacceptable). Thus, in the curl correcting apparatus 700, in the period of time from the timing T26 to the timing at which N (i.e., 50) sheets S are stacked, the correction of the curl correction amount I based on the stacked-bundle-detection correction amount Hs is not performed even if the result detected by the stacked-bundle detection portion 880 has exceeded the allowable value (Unacceptable).

In the curl correcting apparatus 700, a newly stacked sheet is supported in a shape corresponding to the curl state of sheets already stacked on the stacking tray 500. That is, a sheet newly stacked on the stacking tray 500 is affected by the curl state of sheets stacked previously on the stacking tray 500.

In the example illustrated in FIG. 23, a timing T27 is a timing at which more than 10 sheets have been conveyed (the stacked-bundle detection portion 880 performs the detection at a timing at which 10 sheets have been conveyed), and which is earlier than the calculation timing (which corresponds to 50 or more sheets) of the stacked-bundle-detection correction amount Hs. In the curl correcting apparatus 700, there is a timing, such as the timing T27, at which the result detected by the stacked-bundle detection portion 880 is within the allowable value (Acceptable) before the calculation timing is reached. Thus, in the curl correcting apparatus 700, if the curl correction amount I is corrected, before the calculation timing for calculating the stacked-bundle-detection correction amount Hs is reached, by calculating the stacked-bundle-detection correction amount Hs based on the result detected by the stacked-bundle detection portion 880, the overcorrection may be caused and the shape of the stacked bundle may become unstable.

For this reason, in the curl correcting apparatus 700 of the second embodiment, the number of sheets S corrected with the curl correction amount I corrected based on the stacked-bundle-detection correction amount Hs is set at N (i.e., 50). The N (i.e., 50) number of sheets S are stacked without affecting the shape of the stacked bundle. That is, if the number of sheets stacked on the stacking tray 500 is smaller than N, the curl correcting apparatus 700 does not perform the update of the curl correction amount I that is performed based on the stacked-bundle-detection correction amount Hs.

In the example illustrated in FIG. 23, in the curl correcting apparatus 700, at a timing T28 at which 50 sheets have been stacked since the timing T26, the result detected by the inline detection portion 630 is within the allowable value (Acceptable). In addition, in the curl correcting apparatus 700, at the timing T28, the result detected by the stacked-bundle detection portion 880 is within the allowable value (Acceptable). Thus, in the curl correcting apparatus 700, at the timing T28, the curl correction amount I is not corrected, so that the curl correction amount I that was set at the timing T25 is kept.

### Summary of Second Embodiment

As described above, the curl correcting apparatus 700 of the second embodiment causes the inline detection portion 630 to detect the curl state for each of the sheets S conveyed, and calculates the inline-detection correction amount Hi in a case where the curl state has exceeded the allowable value (Unacceptable). In addition, the curl correcting apparatus 700 detects the curl state of the uppermost sheet S of a stacked bundle stacked on the stacking tray 500, and calculates the stacked-bundle-detection correction amount Hs in a case where the curl state has exceeded the allowable value (Unacceptable). The curl correcting apparatus 700 sets the curl correction amount I, based on the inline-detection correction amount Hi and the stacked-bundle-detection correction amount Hs. That is, even in a case where a predetermined curl correction effect cannot be obtained due to the difference in production lot of the sheet S, the change in water content of the sheet S, variations in production of the curl correcting portion 800, and the like, the curl correcting apparatus 700 feed-backs the correction amount of the curl correction amount I, depending on the results detected by the two detection portions.

With this configuration, in the curl correcting apparatus 700, the sheet S can be stably stacked on the stacking tray 500, and the problems, such as the failure of stacking, the fall of the bundle in the conveyance, the failure of feeding in a post-processing apparatus, the failure of alignment, and the failure of stapling, can be suppressed.

In the curl correcting apparatus 700 of the second embodiment, the stacked-bundle detection portion 880 performs the detection each time 10 sheets are stacked on the stacking tray 500. The number (i.e., 10) of sheets S serves as a first set number of sheets.

Thus, the curl correcting apparatus 700 can be suppressed from causing the stacked-bundle detection portion 880 to perform the detection each time a single sheet S is stacked, in a state where the sheets are stacked one after another. As a result, it can be suppressed that the detection result becomes unstable and the curl correction amount I is corrected excessively or insufficiently.

In addition, in a case where the result detected by the stacked-bundle detection portion 880 is within the allowable value (Acceptable), the curl correcting apparatus 700 of the second embodiment does not set the stacked-bundle-detection correction amount Hs. In addition, in a case where the result detected by the stacked-bundle detection portion 880 has exceeded the allowable value (Unacceptable) and the number of the sheets S stacked on the stacking tray 500 has reached N (i.e., 50) larger than 10, the curl correcting apparatus 700 sets the stacked-bundle-detection correction amount Hs. On the other hand, in a case where the result detected by the stacked-bundle detection portion 880 has exceeded the allowable value (Unacceptable) and the number of the sheets S stacked on the stacking tray 500 has not reached N (i.e., 50), the curl correcting apparatus 700 does not set the stacked-bundle-detection correction amount Hs.

With this operation, the curl correcting apparatus 700 can correct the curl correction amount I, based on the stacked-bundle-detection correction amount Hs, in consideration of the influence that the curl state of sheets previously stacked on the stacking tray 500 exerts on a newly stacked sheet. As a result, the curl correcting apparatus 700 can be suppressed from overcorrecting the curl correction amount I, based on the stacked-bundle-detection correction amount Hs, and from making the shape of the stacked bundle unstable.

### Other Embodiments

In the first and the second embodiments, the curl correcting apparatus 700 causes the stacked-bundle detection portion 880 to perform the detection each time 10 sheets (the number of 10 sheets S serves as a first set number of sheets) are conveyed to the stacking tray 500. However, the present disclosure is not limited to this. For example, in a case where the curl correcting apparatus 700 receives print data from the image forming apparatus 1 and printing is performed for obtaining a plurality of copies, the curl correcting apparatus 700 may cause the stacked-bundle detection portion 880 to perform the detection when printing for one copy is switched to printing for another. In other words, the curl correcting apparatus 700 may cause the stacked-bundle detection portion 880 to perform the detection when switching between copies during printing of a plurality of copies.

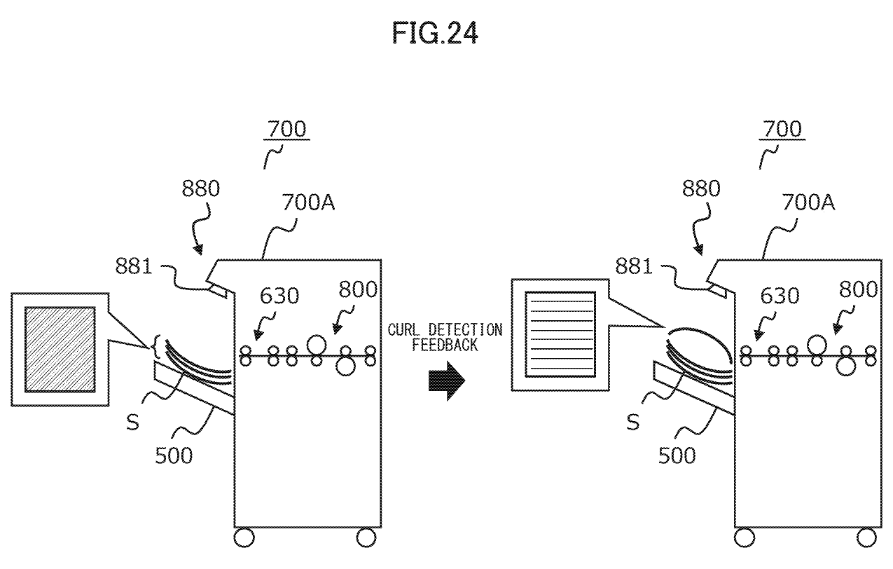

As described above, in a case where the image density varies, the curl that occurs in the sheet S (discharged to the outside) also varies. FIG. 24 illustrates a case where the cycle in which the stacked-bundle detection portion 880 performs the detection is shortened.

FIG. 24 is a diagram illustrating a sheet detected in each detection in the case where the cycle in which the stacked-bundle detection portion 880 performs the detection is shortened. In the example illustrated in FIG. 24, the stacked-bundle detection portion 880 performs the detection in a state where a plurality of sheets having a high image density is stacked, and the stacked-bundle-detection correction amount Hs is calculated based on the result detected by the stacked-bundle detection portion 880. In the curl correcting apparatus 700, in a case where the curl of a sheet S is corrected based on the curl correction amount I corrected by feed-backing the calculated stacked-bundle-detection correction amount Hs, if the sheet S has a low image density distribution of an image formed on the sheet S, a desired curl correction effect may not be obtained.

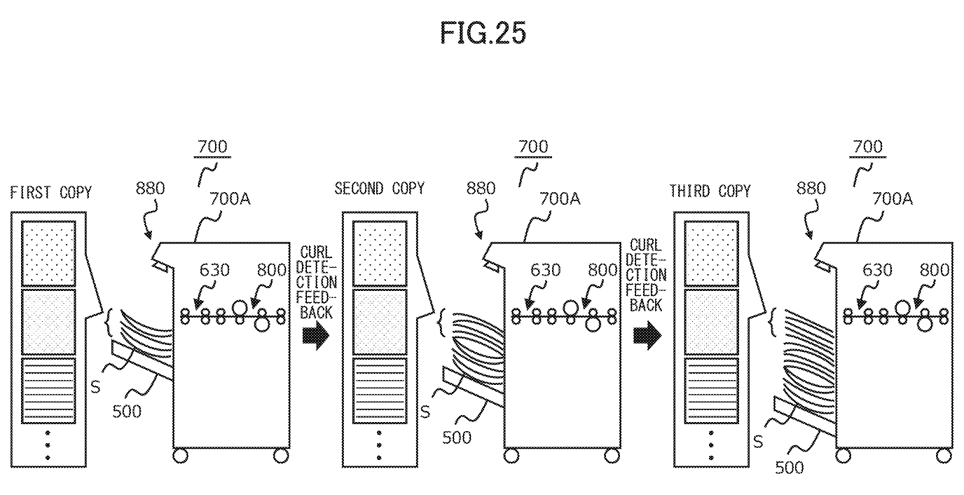

FIG. 25 is a diagram illustrating a sheet detected in each detection in a case where the stacked-bundle detection portion 880 performs the detection when printing for one copy is switched to printing for another. As illustrated in FIG. 25, in a case where a plurality of copies for an image is output, the curl correcting apparatus 700 causes the stacked-bundle detection portion 880 to perform the detection when printing for one copy is switched to printing for another. In the curl correcting apparatus 700, the curl correction amount I is corrected by feed-backing the stacked-bundle-detection correction amount Hs calculated based on the result detected by the stacked-bundle detection portion 880.

With this operation, the distribution of image density of the uppermost sheet S stacked on the stacking tray 500 when the stacked-bundle detection portion 880 performs the detection substantially corresponds to the distribution of image density of a sheet S to be corrected with the corrected curl correction amount I. Thus, the curl correcting apparatus 700 can increase the curl correction effect.

The curl correcting apparatus 700 may be configured in this manner. However, the present disclosure is not limited to the configuration of the curl correcting apparatus 700 in which the stacked-bundle detection portion 880 performs the detection when printing for one copy is switched to printing for another, and in which the curl correcting apparatus 700 calculates the stacked-bundle-detection correction amount Hs and corrects the curl correction amount I each time the detection result has exceeded the allowable value. For example, in a case where the stacked-bundle detection portion 880 performs the detection and the detection result has exceeded the allowable value, the curl correcting apparatus 700 may calculate the stacked-bundle-detection correction amount Hs in a case where the number of sheets stacked on the stacking tray 500 has reached a predetermined number of sheets. That is, in a case where the stacked-bundle detection portion 880 performs the detection and the detection result has exceeded the allowable value, the curl correcting apparatus 700 may not calculate the stacked-bundle-detection correction amount Hs in a case where the number of sheets stacked on the stacking tray 500 has not reached a predetermined number of sheets.

With this operation, the curl correcting apparatus 700 can correct the curl correction amount I, based on the stacked-bundle-detection correction amount Hs, in consideration of the influence that the curl state of sheets previously stacked on the stacking tray 500 exerts on a newly stacked sheet. As a result, the curl correcting apparatus 700 can be suppressed from overcorrecting the curl correction amount I, based on the stacked-bundle-detection correction amount Hs, and from making the shape of the stacked bundle unstable.

In addition, in the curl correcting apparatus 700, the stacked-bundle detection portion 880 may perform the detection at a timing of the main-body adjustment. In the main-body adjustment, the printing is temporarily stopped during the continuous printing performed by the image forming apparatus 1, for example, for adjusting the stabilization of color. Note that the main-body adjustment includes the whole of operations during which the image forming engine 513 stops temporarily. For example, the main-body adjustment includes an operation that temporarily stops the printing, for example, for printing a patch for adjusting the stabilization of color, an operation for supplying the toner, and an operation for adjusting the temperature of the fixing apparatus 58.

In other words, the curl correcting apparatus 700 may cause the stacked-bundle detection portion 880 to perform the detection during the execution of an image forming engine 513, at a time when the operation of the image forming engine 513 for forming an image on the sheet S is temporarily stopped.

In the curl correcting apparatus 700, if the curl state of the sheets S stacked on the stacking tray 500 is detected in a state where the sheets S are stacked one after another, the detection result may not become stable. Thus, the stacked-bundle detection portion 880 has the highest accuracy in the detection when performing the detection at a timing at which the discharge of the sheet S is stopped.

Thus, in the curl correcting apparatus 700, the timing at which the stacked-bundle detection portion 880 performs the detection and the curl correction amount I is corrected by feed-backing the stacked-bundle-detection correction amount Hs may be set at a timing at which the operation of the image forming engine 513 is temporarily stopped. In this configuration, the curl correcting apparatus 700 can cause the stacked-bundle detection portion 880 to perform the detection with high accuracy while keeping the productivity in printing as much as possible.

Note that the configuration of the curl correcting apparatus 700 is not limited to the configuration in which the stacked-bundle detection portion 880 performs the detection when the operation of the image forming engine 513 is temporarily stopped, and in which each time the detection result has exceeded the allowable value, the stacked-bundle-detection correction amount Hs is calculated and the curl correction amount I is corrected. For example, in a case where the stacked-bundle detection portion 880 performs the detection and the detection result has exceeded the allowable value, the curl correcting apparatus 700 may calculate the stacked-bundle-detection correction amount Hs in a case where the number of sheets stacked on the stacking tray 500 has reached a predetermined number of sheets. That is, in a case where the stacked-bundle detection portion 880 performs the detection and the detection result has exceeded the allowable value, the curl correcting apparatus 700 may not calculate the stacked-bundle-detection correction amount Hs in a case where the number of sheets stacked on the stacking tray 500 has not reached the predetermined number of sheets.

With this operation, the curl correcting apparatus 700 can correct the curl correction amount I, based on the stacked-bundle-detection correction amount Hs, in consideration of the influence that the curl state of sheets previously stacked on the stacking tray 500 exerts on a newly stacked sheet. As a result, the curl correcting apparatus 700 can be suppressed from overcorrecting the curl correction amount I, based on the stacked-bundle-detection correction amount Hs, and from making the shape of the stacked bundle unstable.

In the first and the second embodiments, in the curl correcting apparatus 700, the number of sheets that allows the stacked-bundle detection portion 880 to perform the detection is 10. However, the present disclosure is not limited to this, and the number of sheets may be another value. In addition, in the curl correcting apparatus 700, the timing at which the stacked-bundle-detection correction amount Hs is calculated based on the result detected by the stacked-bundle detection portion 880 is set at a timing at which 50 (i.e., N) or more sheets S have been stacked. However, the present disclosure is not limited to this, and the number N of the sheets may be another value. The timing at which the stacked-bundle-detection correction amount Hs is calculated may correspond to the number of the sheets S that is equal to the number of the sheets S that allows the stacked-bundle detection portion 880 to perform the detection. That is, the timing at which the stacked-bundle-detection correction amount Hs is calculated has only to be a timing that overlaps with the timing at which the stacked-bundle detection portion 880 performs the detection and the detection result is obtained.

In the first and the second embodiments, in the curl correcting apparatus 700, the controller 100 performs the image processing on an image captured by the CCD camera 881 of the stacked-bundle detection portion 880, and thereby the curl state of the sheet S is obtained. However, the present disclosure is not limited to this. For example, in the curl correcting apparatus 700, a control unit of the CCD camera 881 may perform the image processing on a captured image, and thereby may obtain the curl state of the sheet S and send the obtained curl state to the controller 100. That is, the controller 100 obtains the curl state of the uppermost sheet S stacked on the stacking tray 500, by receiving the curl state of the sheet S obtained by the CCD camera 881.

In the first and the second embodiments, the curl correcting apparatus 700 includes the inline detection portion 630 and the stacked-bundle detection portion 880. However, the present disclosure is not limited to this. For example, in the curl correcting apparatus 700, the curl state of a sheet conveyed may be detected by an inline detection portion included in the image forming apparatus 1 and disposed upstream of the curl correcting apparatus 700 in the conveyance direction of the sheet S. In addition, in the curl correcting apparatus 700, the curl state of the sheet stacked on the stacking tray 500 may be detected by a stacked-bundle detection portion disposed outside the curl correcting apparatus 700.

In the first and the second embodiments, in the curl correcting apparatus 700, each time a single sheet S is conveyed to the inline detection portion 630, the curl state of the sheet S is detected. However, the present disclosure is not limited to this. For example, in the curl correcting apparatus 700, each time a predetermined number of sheets S is conveyed to the inline detection portion 630, the curl state of the sheet S may be detected.

In the first and the second embodiments, the image forming system 1000 includes the image forming apparatus 1 and the curl correcting apparatus 700 that are separated from each other. However, the present disclosure is not limited to this. For example, in the image forming system 1000, the curl correcting apparatus 700 may be incorporated in the image forming apparatus 1, and thus, the image forming apparatus 1 and the curl correcting apparatus 700 may be integrated with each other.

In the first embodiment, the decurl-amount setting value T is calculated based on a physical-property value of the sheet S that is used by the image forming engine 513 for forming an image and that is set by a user, and on information such as the temperature and humidity of the outside air detected by the environment sensor 840 and an image to be printed. However, the present disclosure is not limited to this. For example, the curl correcting apparatus 700 may calculate the decurl-amount setting value T, based on at least one of information on a physical-property value of the sheet S that is set by a user and that corresponds to the type of the sheet S, information such as the temperature and humidity of the outside air detected by the environment sensor 840, and information on an image to be printed.

The present disclosure can appropriately set the amount of correction.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-008761, filed January 21, 2025, which is hereby incorporated by reference herein in its entirety.

What is claimed is:

1. A curl correcting apparatus comprising:
a curl correcting portion including:
a first rotary member; and
a second rotary member configured to abut against the first rotary member, the curl correcting portion being configured to correct curl of a sheet that passes through a nip portion between the first rotary member and the second rotary member when the first rotary member is pressed by the second rotary member;
a first detection portion configured to detect a curl state of the sheet conveyed in a conveyance path by a conveyance roller;
a second detection portion disposed in a stacking portion configured to stack the sheet discharged from the curl correcting portion, the second detection portion being configured to detect a curl state of the sheet stacked on the stacking portion; and
a control portion configured to adjust a pressing amount by which the second rotary member presses the first rotary member of the curl correcting portion,
wherein the control portion is configured to set the pressing amount based on a first detection result by the first detection portion and a second detection result by the second detection portion.

2. The curl correcting apparatus according to claim 1, wherein the control portion is configured to cause the second detection portion to perform detection each time a first set number of sheets are stacked on the stacking portion.

3. The curl correcting apparatus according to claim 2, wherein the control portion has a first correction amount based on the first detection result and a second correction amount based on the second detection result, the first correction amount and the second correction amount being used when correcting the pressing amount,
wherein the control portion does not set the second correction amount in a case where the second detection result is within a threshold, and
wherein in a case where the second detection result has exceeded the threshold, the control portion
(i) sets the second correction amount in a case where a number of sheets stacked on the stacking portion is larger than a second set number of sheets, and
(ii) does not set the second correction amount in a case where a number of sheets stacked on the stacking portion is smaller than the second set number of sheets.

4. The curl correcting apparatus according to claim 3, wherein the control portion is configured not to change the second correction amount in a period of time from when the control portion sets the second correction amount, until when the second set number of sheets are stacked on the stacking portion.

5. The curl correcting apparatus according to claim 1, wherein the control portion causes the second detection portion to perform detection when switching between copies during printing of a plurality of copies.

6. The curl correcting apparatus according to claim 5, wherein the control portion has a first correction amount based on the first detection result and a second correction amount based on the second detection result, the first correction amount and the second correction amount being used when correcting the pressing amount,
wherein the control portion does not set the second correction amount in a case where the second detection result is within a threshold, and
wherein in a case where the second detection result has exceeded the threshold, the control portion
(i) sets the second correction amount in a case where a number of sheets stacked on the stacking portion has reached a predetermined set number of sheets, and
(ii) does not set the second correction amount in a case where a number of sheets stacked on the stacking portion has not reached the predetermined set number of sheets.

7. The curl correcting apparatus according to claim 1, wherein the control portion is configured to cause the second detection portion to perform detection when an operation of an image forming portion that forms an image on a sheet is temporarily stopped during execution of an image forming job.

8. The curl correcting apparatus according to claim 7, wherein the control portion has a first correction amount based on the first detection result and a second correction amount based on the second detection result, the first correction amount and the second correction amount being used when correcting the pressing amount,
wherein the control portion does not set the second correction amount in a case where the second detection result is within a threshold, and
wherein in a case where the second detection result has exceeded the threshold, the control portion
(i) sets the second correction amount in a case where a number of sheets stacked on the stacking portion has reached a predetermined set number of sheets, and
(ii) does not set the second correction amount in a case where a number of sheets stacked on the stacking portion has not reached the predetermined set number of sheets.

9. The curl correcting apparatus according to claim 1, wherein the control portion has a first correction amount based on the first detection result and a second correction amount based on the second detection result, the first correction amount and the second correction amount being used when correcting the pressing amount, and
wherein the control portion is configured to update the pressing amount by using the first correction amount based on the first detection result each time the first detection portion performs detection.

10. The curl correcting apparatus according to claim 1, wherein the first detection portion is disposed downstream of the curl correcting portion in a sheet conveyance direction.

11. The curl correcting apparatus according to claim 1, wherein the first detection portion includes:
a first sensor configured to detect an edge portion of a sheet in a conveyance direction, and
a second sensor configured to detect the edge portion of a sheet and disposed downstream of the first sensor in the conveyance direction, the second sensor being inclined with respect to an orthogonal direction orthogonal to both of the conveyance direction and a width direction, the width direction being a direction orthogonal to the conveyance direction, and
wherein the curl correcting apparatus is configured to detect a curl state of a sheet based on an elapsed time from detection of the edge portion of the sheet by the first sensor until detection of the edge portion of the sheet by the second sensor, and a conveyance speed of the sheet.

12. The curl correcting apparatus according to claim 1, wherein the second detection portion includes an image capture apparatus disposed above the stacking portion and configured to capture an image of a sheet stacked on the stacking portion from above, and
wherein the second detection portion is configured to detect a curl state of the sheet stacked on the stacking portion based on the image captured by the image capture apparatus.

13. The curl correcting apparatus according to claim 12, wherein the image capture apparatus is configured to capture an image of an uppermost sheet of sheets stacked on the stacking portion from above, and
wherein the image capture apparatus is configured to detect a curl state of the uppermost sheet based on a degree of curvature at a side edge of the uppermost sheet in the image captured by the image capture apparatus.

14. The curl correcting apparatus according to claim 1, wherein the second detection portion includes a distance sensor that is a non-contact sensor, is disposed above the stacking portion, and is configured to measure distances between the distance sensor and a plurality of positions on a surface of a sheet, and
wherein the second detection portion is configured to detect a curl state of a sheet stacked on the stacking portion based on a detection result of the distance sensor.

15. The curl correcting apparatus according to claim 1, wherein the curl state includes an amount by which an edge portion, in a conveyance direction, of a sheet is curled with respect to a center portion of the sheet, and a direction in which the edge portion of the sheet is curled with respect to the center portion of the sheet.

16. The curl correcting apparatus according to claim 1, wherein the curl correcting portion is configured to correct curl of a sheet on which an image is formed by an image forming portion, and
wherein the control portion is configured to set an initial value of the pressing amount based on information on an image forming condition used for image formation by the image forming portion.

17. The curl correcting apparatus according to claim 16, wherein the information on the image forming condition includes information on a type of a sheet on which an image is formed.

18. The curl correcting apparatus according to claim 16, wherein the information on the image forming condition includes information on environment of an outside of the curl correcting apparatus.

19. The curl correcting apparatus according to claim 1, wherein the control portion has a first correction amount based on the first detection result and a second correction amount based on the second detection result, the first correction amount and the second correction amount being used when correcting the pressing amount, and
wherein a first time from when the second correction amount is changed until the second correction amount is next changed is longer than a second time from when the first detection portion detects a curl state, of a sheet, which exceeds an allowable value until the first correction amount is changed.

20. An image forming system comprising:
an image forming portion configured to form an image on a sheet; and
the curl correcting apparatus according to claim 1 and configured to correct curl of the sheet on which an image is formed by the image forming portion.
